(19) United States
(12) Patent Application Publication
(10) Pub. No.: US 2017/0225228 A1
(43) Pub. Date: Aug. 10, 2017

(54) SHAPED ARTICLE MANUFACTURING APPARATUS AND MANUFACTURING METHOD

(71) Applicant: JTEKT CORPORATION, Osaka-shi (JP)

(72) Inventor: Takaya NAGAHAMA, Obu-shi (JP)

(73) Assignee: JTEKT CORPORATION, Osaka-shi (JP)

(21) Appl. No.: 15/427,387

(22) Filed: Feb. 8, 2017

(30) Foreign Application Priority Data
Feb. 9, 2016 (JP) 2016-022884
Dec. 9, 2016 (JP) 2016-239031

(51) Int. Cl. B22F 3/105; B33Y 30/00; B33Y 40/00; B33Y 70/00; B23K 26/70; B22F 1/02; B22F 3/10; B23K 26/00; B23K 26/342; B33Y 10/00; B33Y 50/02

(52) U.S. Cl. CPC B22F 3/1055; B33Y 10/00; B33Y 30/00; B33Y 40/00; B33Y 70/00; B33Y 50/02; B22F 1/02; B22F 3/1017; B23K 26/0006; B23K 26/342; B23K 26/702; B22F 2003/1057; B22F 2301/10; B22F 2302/40; B22F 2998/10; B23K 2203/12

(57) ABSTRACT

A manufacturing apparatus additively shapes an article by sintering or melting and then solidifying a metal powder through irradiation of a shaping optical beam. The manufacturing apparatus includes: a chamber; a metal powder feeding device that feeds the metal powder to an irradiation area; a shaping optical beam irradiation device that applies the shaping optical beam to the metal powder in the irradiation area; an absorptance enhancement assisting unit that performs a predetermined absorptance enhancement assisting treatment on the metal powder; and a shaping unit that, following implementation of the absorptance enhancement assisting treatment, performs a shaping treatment of additively shaping the article by applying the shaping optical beam and thus heating the metal powder to sinter or melt and then solidify.

### INCORPORATION BY REFERENCE

The disclosure of Japanese Patent Application No. 2016-239031 filed on Dec. 9, 2016 including the specification, drawings and abstract is incorporated herein by reference in its entirety.

### BACKGROUND

1. Technical Field

The present disclosure relates to a manufacturing apparatus and a manufacturing method for manufacturing an additively shaped article from a metal powder as a raw material by means of a laser beam.

2. Description of Related Art

Recent years have seen increasingly active development of metal additive manufacturing (AM) that involves sintering or melting and then solidifying a powdery metal through laser beam irradiation, and stacking the solidified layers one after another to manufacture a three-dimensionally shaped article. Studies are underway to apply metal AM to not only prototyping but also mass-production. Metals used for metal AM include maraging steel, stainless steel (SUS), and titanium steel (Ti) that have high absorptances for laser beams with a near-infrared wavelength, which are mostly inexpensive laser beams, allowing for low-cost manufacturing.

However, there is a strong market demand for adopting, as a metal powder material for metal AM, not only maraging steel, stainless steel (SUS), and titanium steel (Ti) but also copper, aluminum, etc. that have low absorptances for laser beams with a near-infrared wavelength. In response to such demand, Japanese Patent Application Publication No. 2011-21218 discloses a metal AM technology that uses aluminum as a metal powder material. According to the technology of JP 2011-21218 A, a laser absorbent having a high absorptance for a laser beam with a near-infrared wavelength is added to an aluminum powder. As a result, when a laser beam with a near-infrared wavelength is applied, the laser absorbent is first heated by absorbing the laser beam with a near-infrared wavelength, and then that heat conducts to the aluminum powder, heating and keeping hot the aluminum powder. Under this condition, the aluminum powder is further heated and melted by irradiation of the laser beam with a near-infrared wavelength and by heat from the laser absorbent.

### SUMMARY

However, in the technology of JP 2011-21218 A, the laser absorbent itself may add to the cost. Further, the laser absorbent mixed with the aluminum powder may constitute impurities and adversely affect the strength etc. of a product.

The present disclosure provides a manufacturing apparatus and a manufacturing method that allow low-cost production of a three-dimensionally shaped article by additive shaping while using a metal powder material that has a low absorptance for a laser beam with a near-infrared wavelength.

A shaped article manufacturing apparatus according to first aspect of the present disclosure is a manufacturing apparatus that additively shapes an article by sintering or melting and then solidifying a metal powder through irradiation of a shaping optical beam, and includes: a chamber that is configured to isolate inside air from outside air; a metal powder feeding device that is provided inside the chamber and feeds the metal powder to an irradiation area of the shaping optical beam; a shaping optical beam irradiation device that applies the shaping optical beam to the metal powder inside the chamber fed to the irradiation area; an absorptance enhancement assisting unit that performs a predetermined absorptance enhancement assisting treatment on the metal powder to enhance the absorptance of the shaping optical beam in the metal powder to be irradiated with the shaping optical beam; and a shaping unit that, following implementation of the absorptance enhancement assisting treatment, performs a shaping treatment of additively shaping the article by applying the shaping optical beam to the metal powder fed to the irradiation area and thus heating the metal powder to sinter or melt and then solidify.

Thus, this shaped article manufacturing apparatus applies the shaping optical beam to the metal powder after performing the absorptance enhancement assisting treatment for enhancing the absorptance of the shaping optical beam in the metal powder by the absorptance enhancement assisting unit. As a result, the shaping optical beam is well absorbed by the metal powder. Accordingly, the metal powder is well heated by short-time irradiation of the shaping optical beam to sinter or melt and then solidify, so that time required for additive shaping can be reduced and shaped articles can be manufactured at low cost.

A shaped article manufacturing method according to second aspect of the present disclosure is a manufacturing method of additively shaping an article by sintering or melting and then solidifying a metal powder through irradiation of a shaping optical beam. The shaped article manufacturing method includes: feeding the metal powder to an irradiation area of the shaping optical beam; performing a predetermined absorptance enhancement assisting treatment on the metal powder to enhance the absorptance of the shaping optical beam in the metal powder to be irradiated with the shaping optical beam; and following implementation of the absorptance enhancement assisting treatment, performing a shaping treatment of additively shaping the article by applying the shaping optical beam to the metal powder fed to the irradiation area and thus heating the metal powder to sinter or melt and then solidify. Thus, a shaped article similar to the shaped article manufactured according to first aspect can be produced.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of a manufacturing apparatus according to first and second embodiments;

FIG. 2 is a top view of a metal powder feeding device in FIG. 1;

FIG. 3 is a graph showing a relation between a laser beam wavelength and an absorptance by metal materials;

FIG. 4 is a partially transparent view of a shaping optical beam irradiation device in FIG. 1;

FIG. 5 is a schematic view illustrating a state where an oxide film is formed on a surface of a thin film layer;

FIG. 6 is a graph showing a relation between a film thickness of an oxide film and an absorptance of a near-infrared laser beam for copper;

FIG. 7 is Flowchart 1 of a manufacturing method according to the first embodiment;

FIG. 8A is a view showing a state of irradiation of a short-wavelength laser beam in a preheating treatment of FIG. 7;

FIG. 8B is a view showing a state of irradiation of the near-infrared laser beam and the short-wavelength laser beam in an oxide film forming treatment of FIG. 7;

FIG. 8C is a view showing a state where an oxide film is formed at a plurality of positions in the oxide film forming treatment of FIG. 7;

FIG. 8D is a view illustrating a state of irradiation of the near-infrared laser beam in a shaping treatment of FIG. 7;

FIG. 8E is a view showing a state where a solidified thin film is formed at a plurality of positions in the shaping treatment of FIG. 7;

FIG. 9A is a view showing a state of irradiation of the near-infrared laser beam and the short-wavelength laser beam in an oxide film forming treatment of a second embodiment;

FIG. 9B is a view showing a state of irradiation of the near-infrared laser beam in a shaping treatment of the second embodiment;

FIG. 10 is a view showing a state of irradiation of the near-infrared laser beam and the short-wavelength laser beam in an oxide film forming treatment of a third embodiment;

FIG. 11 is a schematic view of a manufacturing apparatus according to the third embodiment;

FIG. 12 is Flowchart 2 of a manufacturing method of the third embodiment;

FIG. 13A is a view showing a state of irradiation of the near-infrared laser beam in the oxide film forming treatment of the third embodiment;

FIG. 13B is a view showing a state where a plurality of oxide films are formed in the oxide film forming treatment of the third embodiment;

FIG. 13C is a view showing a state of irradiation of the near-infrared laser beam in a shaping treatment of the third embodiment;

FIG. 14 is a schematic view of a manufacturing apparatus according to a fourth embodiment;

FIG. 15 is a schematic view of a manufacturing apparatus according to a fifth embodiment; and

FIG. 16 is Flowchart 3 of a manufacturing method of the fifth embodiment.

### DETAILED DESCRIPTION OF EMBODIMENTS

A manufacturing apparatus of a three-dimensionally shaped article (corresponding to a shaped article) according to a first embodiment of the present disclosure will be described based on the drawings. This three-dimensionally shaped article manufacturing apparatus is an apparatus that additively shapes a three-dimensional article by sintering or melting and then solidifying a metal powder 15 through irradiation of mainly a shaping optical beam to be described in detail later. In this embodiment, the shaping optical beam is a laser beam with a near-infrared wavelength, and will be hereinafter referred to as a near-infrared laser beam L1.

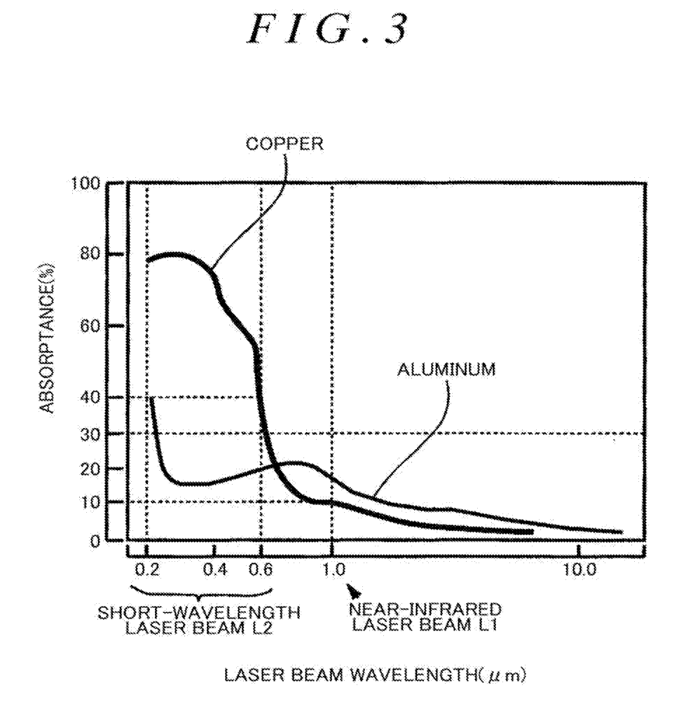

The metal powder 15 is intended as a “low-absorptance material” of which the absorptance for a laser beam with a near-infrared wavelength at room temperature is equal to or lower than a predetermined value. For example, the predetermined value here is an absorptance of 30% (see FIG. 3). In this case, copper, aluminum, etc. are available as the “low-absorptance material,” and copper particles, which are a copper powder, will be selected and described as the metal powder 15 in the following embodiments. In this embodiment, a three-dimensionally shaped article will be described as being additively shaped by melting and then solidifying the metal powder 15, and not by sintering the metal powder 15. However, a three-dimensionally shaped article may be manufactured by sintering, instead of melting.

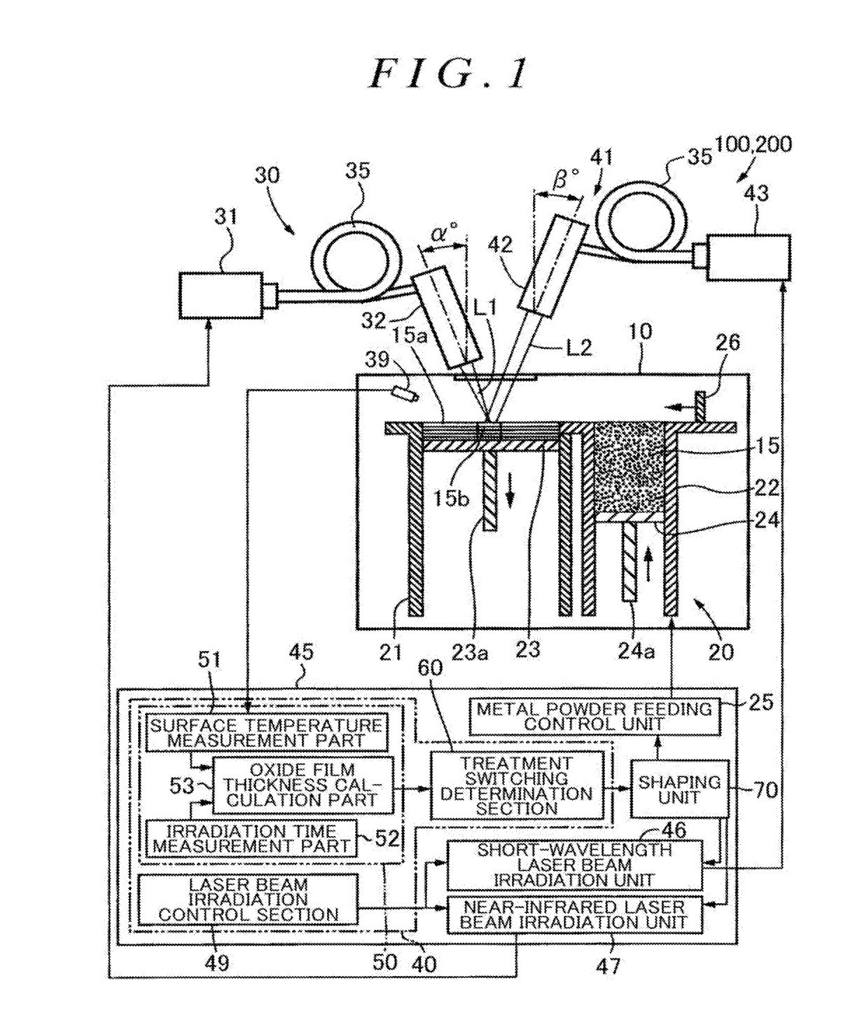

FIG. 1 is a schematic view of a manufacturing apparatus 100 of the first embodiment according to the present disclosure. The manufacturing apparatus 100 includes a chamber 10, a metal powder feeding device 20, a shaping optical beam irradiation device 30, an absorptance enhancement assisting unit 40, an assisting optical beam irradiation device 41, and a shaping unit 70. The absorptance enhancement assisting unit 40 and the shaping unit 70 are provided in a controller 45. The absorptance enhancement assisting unit 40 includes a laser beam irradiation control section 49, a film thickness estimation section 50, and a treatment switching determination section 60.

The chamber 10 is a casing formed in a substantially rectangular parallelepiped shape, and is a container capable of isolating inside air from outside air. The chamber 10 includes a device (not shown) that can replace the air inside the chamber 10 with an inert gas, such as a helium (He), nitrogen (N2), or argon (Ar) gas. Alternatively, the chamber 10 may be configured so that inside of the chamber 10 can be depressurized instead of being replaced with an inert gas.

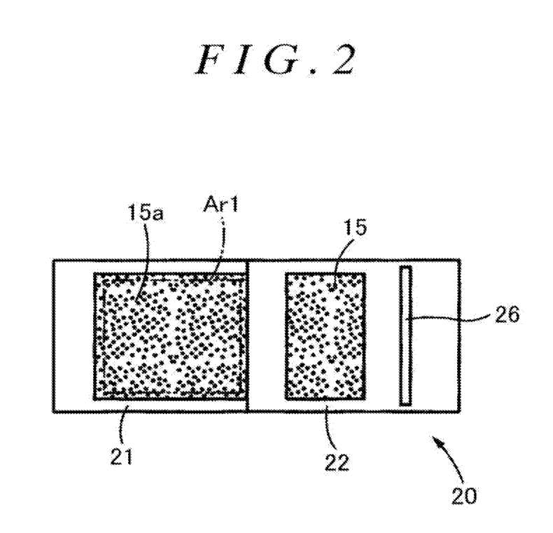

The metal powder feeding device 20 is provided inside the chamber 10, and feeds the metal powder 15, which is a raw material of the three-dimensionally shaped article, to an irradiation area Ar1 (see FIG. 2) of the near-infrared laser beam L1 (corresponding to a shaping optical beam). The metal powder 15 is a copper (Cu) powder. The metal powder 15 here refers to an aggregate of a plurality of copper particles.

As shown in FIG. 1 and FIG. 2, the metal powder feeding device 20 includes a shaping container 21 and a powder housing container 22. As shown in FIG. 1, a shaped article lifting table 23 is provided inside the shaping container 21. A thin film layer 15a of the metal powder 15 is formed on the shaped article lifting table 23. Then, mainly the near-infrared laser beam L1 is applied to the thin film layer 15a to melt the metal powder 15 of the thin film layer 15a, and thereafter the metal powder 15 is solidified to form a solidified thin film layer 15b. Next, the shaped article lifting table 23 is moved downward, and another thin film layer 15a is formed in the same manner. Then, mainly the near-infrared laser beam L1 is applied to the thin film layer 15a to melt the metal powder 15 of the thin film layer 15a, and thereafter the metal powder 15 is solidified to form another solidified thin film layer 15b, which is added on the solidified thin film layer 15b that is formed earlier. This operation is repeated to produce a three-dimensionally shaped article.

In the powder housing container 22, the metal powder 15 is housed on a feeding table 24, and the feeding table 24 is moved upward to feed the metal powder 15. Support shafts 23a, 24a are respectively mounted to the shaped article lifting table 23 and the feeding table 24. The support shafts 23a, 24a are connected to a driving device (not shown) and are moved up and down as the driving device is activated.

The metal powder feeding device 20 is further provided with a recoater 26 that moves across the entire regions of openings of the shaping container 21 and the powder housing container 22. The recoater 26 moves from right to left in FIG. 1 and FIG. 2. Thus, the metal powder 15 that is fed by the raised feeding table 24 is carried onto the shaped article lifting table 23, and the thin film layer 15a of the metal powder 15 is formed on the shaped article lifting table 23. The thickness of the thin film layer 15a is determined by the amount of descent of the shaped article lifting table 23. In this embodiment, the thickness of the thin film layer 15a is approximately 50 μm to 100 μm. However, this thickness is given merely as an example, and the thickness is not limited to this example.

The shaping optical beam irradiation device 30 applies the near-infrared laser beam L1 to a surface of the thin film layer 15a of the metal powder 15 inside the chamber 10 fed to the irradiation area Ar1 (see FIG. 2) by the metal powder feeding device 20. As shown in FIG. 1, the shaping optical beam irradiation device 30 includes a laser oscillator 31 and a laser head 32. The laser oscillator 31 includes an optical fiber 35 that transmits the near-infrared laser beam L1 oscillated by the laser oscillator 31 to the laser head 32.

The laser oscillator 31 generates the near-infrared laser beam L1, which is a continuous-wave (CW) laser beam, by oscillating so that the wavelength becomes a preset, predetermined near-infrared wavelength. The size of the wavelength of the near-infrared laser beam L1 is around 1.0 μm. Specifically, HoYAG (about 1.5 μm in wavelength), yttrium vanadate (YVO; about 1.06 μm in wavelength), ytterbium (Yb; about 1.09 μm in wavelength), a fiber laser, etc. can be adopted as the near-infrared laser beam L1. Thus, the laser oscillator 31 can be produced inexpensively, as well as operated inexpensively owing to low energy consumption. As shown in the graph of FIG. 3 representing a relation between a laser beam wavelength (μm) and a laser beam absorptance (%) by materials, the near-infrared laser beam L1 has a comparatively low absorptance in copper and aluminum, with the absorptance being no higher than 30%.

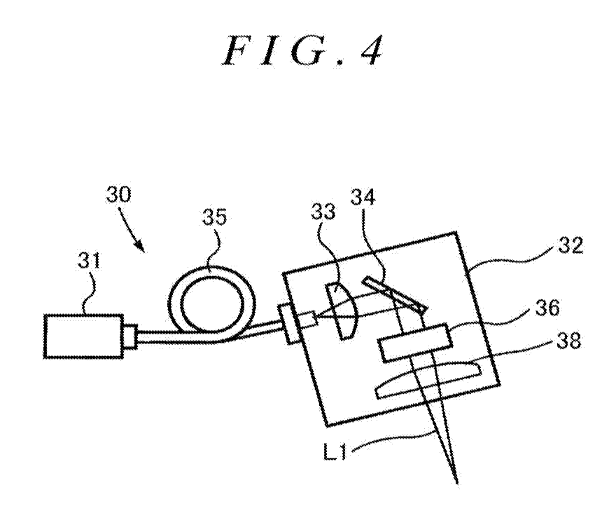

As shown in FIG. 1, the laser head 32 is disposed at a predetermined distance from the surface of the thin film layer 15a of the metal powder 15 inside the chamber 10, at a predetermined angle α° relative to a perpendicular direction. As shown in FIG. 4, the laser head 32 includes a collimating lens 33, a mirror 34, a galvanometer scanner 36, and an fβ lens 38. The collimating lens 33, the mirror 34, the galvanometer scanner 36, and the fβ lens 38 are disposed inside a casing of the laser head 32. The collimating lens 33 collimates and converts the near-infrared laser beam L1 emitted from the optical fiber 35 into a parallel beam.

The mirror 34 changes a travel direction of the collimated near-infrared laser beam L1 so that the near-infrared laser beam L1 enters the galvanometer scanner 36. In this embodiment, the mirror 34 changes the travel direction of the near-infrared laser beam L1 90 degrees.

The galvanometer scanner 36 changes the travel direction of a laser beam L, and applies the near-infrared laser beam L1 through the fθ lens 38 at a predetermined position in the surface of the thin film layer 15a. That is, the angle at which the near-infrared laser beam L1 oscillated by the laser oscillator 31 is applied by the laser head 32 can be changed to a desired angle by the galvanometer scanner 36. The predetermined position at which the near-infrared laser beam L1 is applied will be described in detail later. For example, a known scanner including a pair of movable mirrors (not shown) that can swivel in two orthogonal directions is used as the galvanometer scanner 36. The fθ lens 38 is a lens that condenses the parallel laser beam L entering from the galvanometer scanner 36. The laser beam L applied from the laser head 32 is applied into the chamber 10 through a transparent glass or resin provided on a top surface of the chamber 10.

The absorptance enhancement assisting unit 40 is a control unit that is provided in the controller 45 (see FIG. 1) and implements an absorptance enhancement assisting treatment using the near-infrared laser beam L1 (shaping optical beam) described above and a short-wavelength laser beam L2 (assisting optical beam) to be described later. The absorptance enhancement assisting unit 40 can employ various predetermined means (absorptance enhancement assisting treatments). In the first embodiment, the absorptance enhancement assisting treatment is a treatment of forming an oxide film OM of a predetermined film thickness on the surface of the thin film layer 15a of the metal powder 15.

This treatment can enhance the absorptance of the near-infrared laser beam L1 in the metal powder 15 (copper powder) in a shaping treatment, to be described later, that is performed after the absorptance enhancement assisting treatment. Irradiation of the near-infrared laser beam L1 (shaping optical beam) and the short-wavelength laser beam L2 (assisting optical beam) is controlled by the laser beam irradiation control section 49.

For convenience of description, the short-wavelength laser beam, to be described in detail later, will be briefly described here. The short-wavelength laser beam L2 is a laser beam with a wavelength (e.g., wavelength of 0.2 to 0.6 μm) shorter than a near-infrared wavelength. In this embodiment, the short-wavelength laser beam L2 is a continuous-wave (CW) laser beam. To look at the graph of FIG. 3 showing the relation between the laser beam wavelength (μm) and the laser beam absorptance (%) by materials, the short-wavelength laser beam has a higher absorptance in copper than the near-infrared laser beam. Examples of a short-wavelength laser include a UV laser, green laser, and blue laser. In the first embodiment, a blue laser is used as an example.

In the first embodiment, the absorptance enhancement assisting treatment implemented (controlled) by the absorptance enhancement assisting unit 40 includes a preheating treatment performed on the surface of the thin film layer 15a and an oxide film forming treatment performed on the surface of the thin film layer 15a following the preheating treatment. First, in the preheating treatment, the short-wavelength laser beam L2 (assisting optical beam) having a high absorptance in the metal powder 15 (copper powder) is applied to the surface of the thin film layer 15a under control of the short-wavelength laser beam irradiation unit 46. This irradiation heats an irradiation position in the surface of the thin film layer 15a of the metal powder 15 inside the chamber 10 to a temperature not exceeding the melting point of copper (1060° C.), for example, to a temperature of 600° C. to 800° C. At this point, the oxide film OM is not yet formed at the irradiation position in the surface of the thin film layer 15a.

Having originally a high absorptance in copper as shown in FIG. 3, the short-wavelength laser beam L2 can sufficiently heat the metal powder 15 even at low power level. Accordingly, the surface of the thin film layer 15a can be heated (preheated) comparatively inexpensively with the short-wavelength laser beam L2. Next, in the oxide film forming treatment, the surface of the thin film layer 15a is heated (preheated), and with the base temperature of the thin film layer 15a thus raised, the short-wavelength laser beam L2 and the near-infrared laser beam L1 are overlappingly applied at the same time to form the oxide film OM on the surface of the thin film layer 15a.

The purpose of thus preheating the surface of the thin film layer 15a is to facilitate formation of the oxide film OM on the surface of the thin film layer 15a in the oxide film forming treatment. That is, the base temperature of the thin film layer 15a is raised by preheating. Accordingly, when the short-wavelength laser beam L2 and the near-infrared laser beam L1 are overlappingly applied at the same time, the width of temperature by which the thin film layer 15a need be raised in temperature before the oxide film OM is formed can be narrowed. Thus, time required for overlapping irradiation of the short-wavelength laser beam L2 and the near-infrared laser beam L1 can be reduced, so that the oxide film OM can be formed in a short time and at low power level.

It is known that copper near its melting point has an enhanced absorptance for the near-infrared laser beam L1 and the oxide film OM (cuprous oxide) is formed on a surface irradiated therewith. Therefore, preheating the surface of the thin film layer 15a to a temperature of 600° C. to 800° C. by applying the short-wavelength laser beam L2 can favorably reduce the irradiation time and the power level (required energy) for overlapping irradiation of the short-wavelength laser beam L2 and the near-infrared laser beam L1 in the oxide film forming treatment. Thus, in the first embodiment, the absorptance enhancement assisting treatment consists of the preheating treatment of preheating the surface of the thin film layer 15a by applying the short-wavelength laser beam L2, and the oxide film forming treatment of forming the oxide film OM on the surface of the thin film layer 15a, which has been preheated and kept hot, by overlappingly applying the short-wavelength laser beam L2 and the near-infrared laser beam L1.

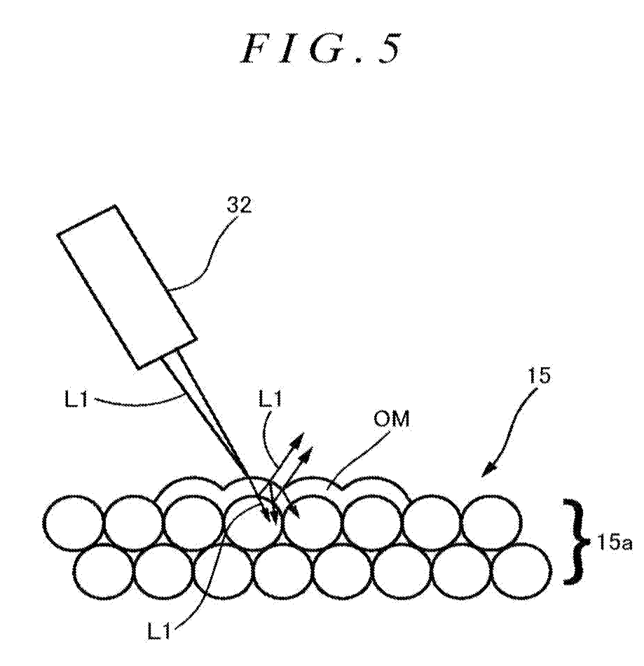

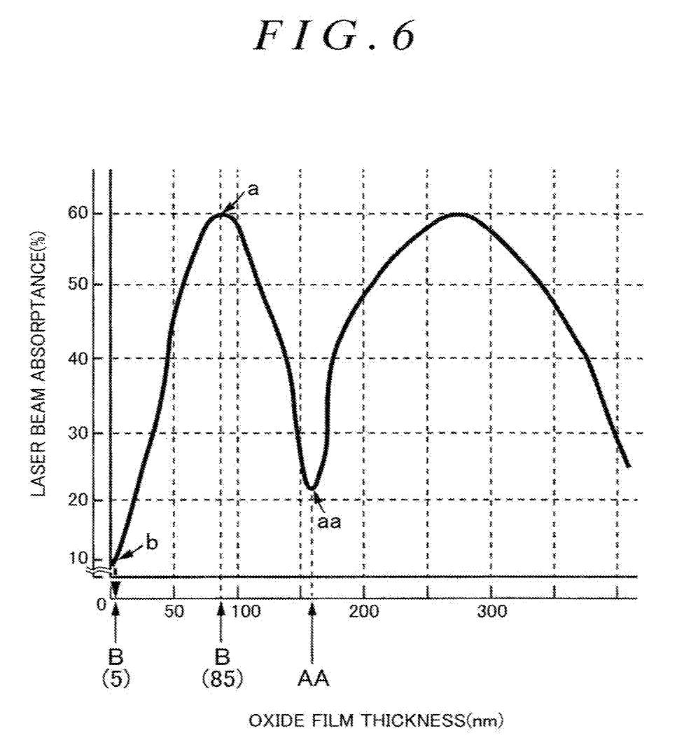

Here, a relation between the absorptance of the near-infrared laser beam L1 and a film thickness of the oxide film OM for copper will be described. As shown in FIG. 5, when the oxide film OM is formed on a surface of each copper particle of the metal powder 15, the near-infrared laser beam L1 applied toward the oxide film OM is efficiently absorbed into the surfaces of the copper particles and heats the copper particles well, while passing through the oxide film OM or reflecting inside the oxide film OM. The effect of the oxide film OM enhancing the absorptance of the near-infrared laser beam L1 in copper particles is based on public knowledge. Therefore, description of the principle etc. that causes this effect will be omitted. The absorptance of the near-infrared laser beam L1 in copper particles varies with the film thickness of the oxide film OM as shown in the graph of FIG. 6.

The graph of FIG. 6 is experimental data, with the horizontal axis representing the film thickness (nm) of the oxide film OM formed on a surface of a copper member and the vertical axis representing the absorptance (%) of the near-infrared laser beam L1 in the copper member when the near-infrared laser beam L1 was applied to the copper member through the oxide film OM formed thereon. This experiment used a 10 mm×10 mm square bar, instead of copper particles, as an object for irradiation of the near-infrared laser beam L1. On the assumption that approximate results can be obtained when the oxide film OM is formed on surfaces of copper particles, the data on the copper member shown in FIG. 6 will be adopted.

To look at the graph of FIG. 6, in relation to the film thickness of the oxide film OM, the absorptance of the near-infrared laser beam L1 has a periodicity of a maximum value and a minimum value appearing alternately as the film thickness changes in a plus direction. The absorptance is lowest when the film thickness of the oxide film OM is zero. Accordingly, the present inventors set the predetermined film thickness of the oxide film OM to be within such a range that, in relation to the absorptance having that periodicity, the film thickness is larger than zero but not larger than a first maximum film thickness A corresponding to a first maximum value a that is the maximum value of the absorptance appearing first. Thus, the absorptance of copper particles after the oxide film is formed thereon is reliably increased compared with the absorptance of copper particles on which no oxide film is formed.

Conditions of the above experiment are as follows. The near-infrared laser beam L1 used was a YAG laser, which was a continuous-wave (CW) laser beam. The oxide film OM was formed inside a heating furnace. The film thickness of the oxide film OM was measured by the sequential electrochemical reduction analysis (SERA) method. The SERA method is a publicly-known film thickness measurement method. Specifically, this method involves first bringing an electrolyte in contact with a surface of metal, and then applying a minute electric current from an electrode to cause a reduction reaction. Here, as each substance has a specific reduction potential, the film thickness can be calculated by measuring the time required for reduction. The particle size of the copper particles of the metal powder 15 (copper powder) to which the data in the graph of FIG. 6 is applied is within a range of 20 μm to 60 μm, with an average particle size D50 being approximately 40 μm. The particle size was measured by a publicly-known laser diffraction method. The data in FIG. 6 is given merely as an example of the relation between the absorptance of the near-infrared laser beam L1 and the film thickness of the oxide film OM, and numerical values etc. are not limited to those of this example.

The assisting optical beam irradiation device 41 shown in FIG. 1 is a device that is included in the manufacturing apparatus 100 and applies the assisting optical beam having a wavelength different from that of the near-infrared laser beam L1 toward the metal powder 15. Irradiation of the assisting optical beam by the assisting optical beam irradiation device 41 is controlled by the absorptance enhancement assisting unit 40. As described above, the assisting optical beam is the short-wavelength laser beam L2 having a wavelength (e.g., wavelength of 0.2 μm to 0.6 μm) shorter than a near-infrared wavelength.

As also described above, the short-wavelength laser beam L2 has a higher absorptance in copper and aluminum, for example, than a laser beam with a near-infrared wavelength as shown in the graph of FIG. 3 showing the relation between the laser beam wavelength (μm) and the laser beam absorptance (%) by materials. However, operating cost of the short-wavelength laser beam L2 is higher than that of a laser beam with a near-infrared wavelength. In the present disclosure, therefore, the short-wavelength laser beam L2 (assisting optical beam) is used mainly for forming the oxide film OM as shown in FIG. 5 in the absorptance enhancement assisting treatment, and not for melting the metal powder 15 (shaping treatment) that requires high power level.

The assisting optical beam irradiation device 41 is different from the shaping optical beam irradiation device 30 in terms of the wavelength of a laser beam oscillated by a laser oscillator 43. Another difference from the shaping optical beam irradiation device 30 is that the assisting optical beam irradiation device 41 does not have a galvanometer scanner. Accordingly, the laser beam is applied from a laser head 42 in only a constant direction.

The laser head 42 of the assisting optical beam irradiation device 41 is disposed at a predetermined angle β° relative to the perpendicular direction so as not to interfere with the laser head 32 of the shaping optical beam irradiation device 30. Moreover, the laser head 42 of the assisting optical beam irradiation device 41 is moved by an XY robot (not shown), and thereby the irradiation position of the laser beam is controlled. Thus, the irradiation position of the short-wavelength laser beam L2 is movable on X- and Y-axes over the surface of the thin film layer 15a of the metal powder 15 inside the chamber 10. An XY plane in this embodiment is a plane parallel to a horizontal plane.

The short-wavelength laser beam L2 can be applied with a spot diameter larger than a spot diameter of the near-infrared laser beam L1. In other words, it is possible to apply the short-wavelength laser beam L2 at lower power density by increasing the spot diameter. The short-wavelength laser beam L2 is applied inside the irradiation area Ar1 shown in FIG. 2, and the position of irradiation performed under control of the XY robot is controlled by the absorptance enhancement assisting unit 40. As the assisting optical beam irradiation device 41 is otherwise the same as the shaping optical beam irradiation device 30, detailed description and illustration thereof will be omitted.

The film thickness estimation section 50 of the absorptance enhancement assisting unit 40 estimates the film thickness of the oxide film OM formed on the surface of the thin film layer 15a by the absorptance enhancement assisting treatment. As shown in FIG. 1, the film thickness estimation section 50 includes a surface temperature measurement part 51, an irradiation time measurement part 52, and an oxide film thickness calculation part 53.

The surface temperature measurement part 51 measures a surface temperature T of the thin film layer 15a while the surface of the thin film layer 15a is overlappingly irradiated with the short-wavelength laser beam L2 and the near-infrared laser beam L1 in the oxide film forming treatment. Here, the surface temperature T is measured with a non-contact infrared radiometer 39 (see FIG. 1). However, the temperature measurement is not limited to this aspect and may be performed with any instrument. Data on the measured surface temperature of the thin film layer 15a is sent to the oxide film thickness calculation part 53.

During the oxide film forming treatment, the irradiation time measurement part 52 measures each irradiation time H for which the surface of the thin film layer 15a is overlappingly irradiated with the short-wavelength laser beam L2 and the near-infrared laser beam L1. In this case, the irradiation time H may be actually measured. However, the time measurement is not limited to this aspect, and alternatively, preset irradiation time data may be acquired from the controller 45. Thereafter, the irradiation time data is sent to the oxide film thickness calculation part 53.

The oxide film thickness calculation part 53 calculates and estimates the film thickness of the oxide film OM based on the measured surface temperature T and the measured irradiation time H. The oxide film OM is formed to a thickness corresponding to the surface temperature T of the thin film layer 15a that rises under overlapping irradiation of the short-wavelength laser beam L2 and the near-infrared laser beam L1, and to the irradiation time H (irradiation duration time) of overlapping irradiation. In short, the film thickness of each oxide film OM can be calculated from the surface temperature T and the irradiation time H.

The treatment switching determination section 60 of the absorptance enhancement assisting unit 40 determines whether the film thickness of the oxide film OM calculated by the oxide film thickness calculation part 53 has reached a predetermined film thickness. Upon determining that the film thickness of the oxide film OM has reached the predetermined film thickness, the treatment switching determination section 60 switches the treatment to be implemented from the absorptance enhancement assisting treatment to the shaping treatment by the shaping unit 70 to be described later.

In the case where there are a plurality of formation positions of the oxide film OM as in this embodiment, the treatment switching determination section 60 switches the treatment to be implemented from the absorptance enhancement assisting treatment to the shaping treatment by the shaping unit 70, to be described later, after all the oxide films OM are formed.

The shaping unit 70 is a control unit that, following implementation of the absorptance enhancement assisting treatment, activates the shaping optical beam irradiation device 30 through the near-infrared laser beam irradiation unit 47 of the controller 45 to apply the near-infrared laser beam L1 (shaping optical beam) to the oxide film OM of the predetermined film thickness formed on the surface of the thin film layer 15a.

However, the shaping unit 70 is not limited to this aspect; the shaping unit 70 may instead activate the shaping optical beam irradiation device 30 and the assisting optical beam irradiation device 41 by the near-infrared laser beam irradiation unit 47 and the short-wavelength laser beam irradiation unit 46 of the controller 45, to apply the near-infrared laser beam L1 (shaping optical beam) and the short-wavelength laser beam L2 (assisting optical beam) at the same time toward the oxide film OM.

As a result, mainly the near-infrared laser beam L1 is well absorbed into the copper particles through the surfaces of the copper particles present in a surface layer of the thin film layer 15a according to the film thickness of the oxide film OM. In this way, the shaping unit 70 performs the shaping treatment of additively shaping the article by heating the thin film layer 15a, and melting and then solidifying the thin film layer 15a.

Specifically, under irradiation of mainly the near-infrared laser beam L1, the temperature of the copper particles in the surface layer of the thin film layer 15a rises beyond the melting point of copper, and the copper particles melt in a short time. Then, heat of the heated copper particles of the thin film layer 15a causes copper particles of a lower layer that are in contact with the copper particles of the surface layer on a lower side of the copper particles of the surface layer to rise in temperature and melt. Thus, the thin film layer 15a melts in a short time by a chain reaction. Thereafter, as the melted thin film layer 15a is cooled, the thin film layer 15a and the solidified thin film layer 15b that is already formed underneath are appropriately joined together at an interface to additively shape the article.

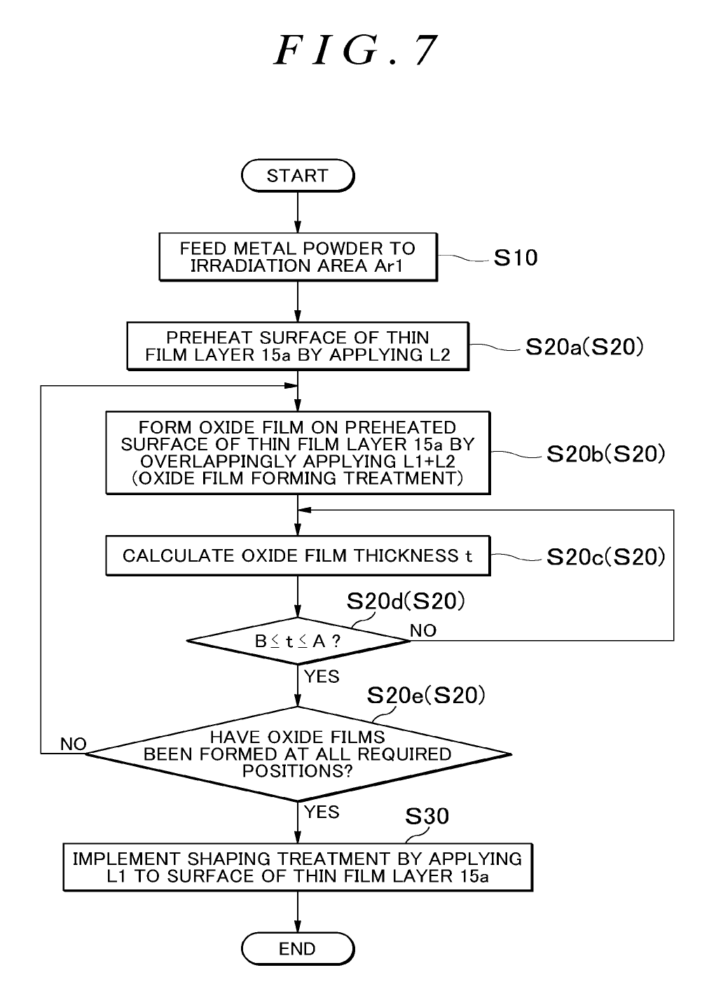

Next, a shaped article manufacturing method will be described based on Flowchart 1 of FIG. 7. The shaped article manufacturing method includes a metal powder feeding step S10, an absorptance enhancement assisting step S20, and a shaping step S30. The absorptance enhancement assisting step S20 includes a preheating treatment step S20a, an oxide film forming treatment step S20b, a film thickness calculation step S20c, a film thickness determination step S20d, and a treatment switching determination step S20e.

First, a preparatory stage will be described. To start with, the metal powder 15 is input into the powder housing container 22. Next, air inside the chamber 10 of the manufacturing apparatus 100 is replaced with a He gas, for example, by the gas replacement device (not shown). Here, 10% of the air need not be replaced. Such an amount of air containing oxygen that the oxide film OM of a nanometer (nm) order can be formed on the surface of the thin film layer 15a may remain inside the chamber 10. The amount of air to be replaced is determined in advance by experiment etc.

Thus, the amount of oxide remaining inside the shaped article upon completion of the shaped article is minimized, so that the strength of the manufactured shaped articles is maintained at a certain level or higher. Moreover, unintended combustion is avoided during irradiation of the laser beams.

In the metal powder feeding step S10, a metal powder feeding control unit 25 of the controller 45 activates the metal powder feeding device 20 to feed the metal powder 15 onto the shaped article lifting table 23 and form the thin film layer 15a of the metal powder 15 in the irradiation area Ar1. For this purpose, first, the metal powder feeding control unit 25 raises the feeding table 24 with the metal powder 15 placed thereon, and lowers the shaped article lifting table 23 by an amount corresponding to one layer of the thin film layer 15a.

Then, the recoater 26 is moved from right to left in FIG. 1 to feed the metal powder 15 from the powder housing container 22 to the shaping container 21, and form the thin film layer 15a of powder on the shaped article lifting table 23.

Next, in the absorptance enhancement assisting step S20, the predetermined absorptance enhancement assisting treatment is performed on the metal powder 15 under control of the absorptance enhancement assisting unit 40 to enhance the absorptance of the near-infrared laser beam L1 (shaping optical beam) in the metal powder 15. Here, as described above, the absorptance enhancement assisting treatment is the treatment of forming the oxide film OM on the surface of the thin film layer 15a using the near-infrared laser beam L1 (shaping optical beam) and the short-wavelength laser beam L2 (assisting optical beam).

Specifically, in the preheating treatment step S20a (absorptance enhancement assisting step S20), the preheating treatment for preheating the metal powder 15 by applying the short-wavelength laser beam L2 is performed. In the preheating treatment step S20a, the laser beam irradiation control section 49 included in the absorptance enhancement assisting unit 40 controls the short-wavelength laser beam irradiation unit 46, and activates the assisting optical beam irradiation device 41 first.

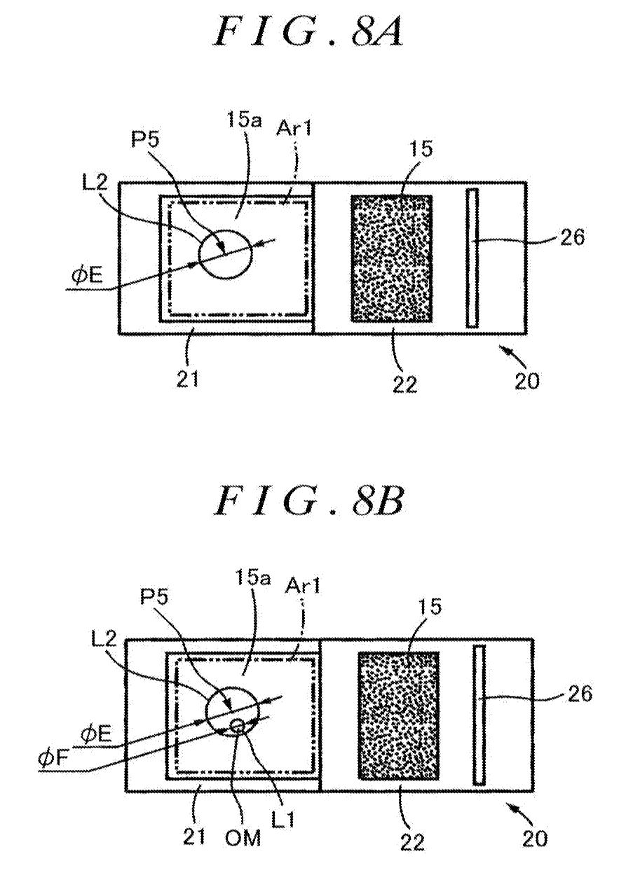

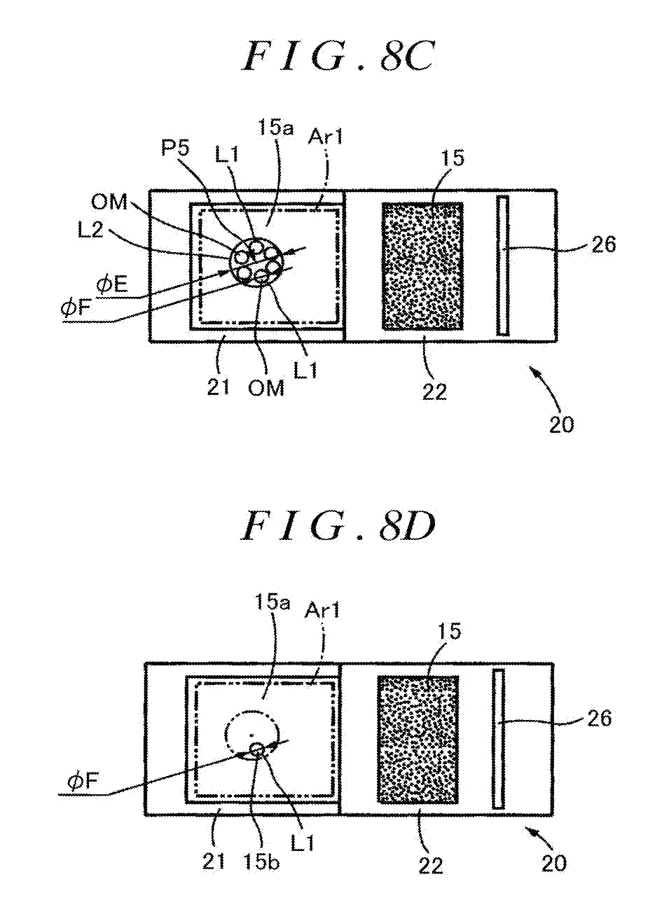

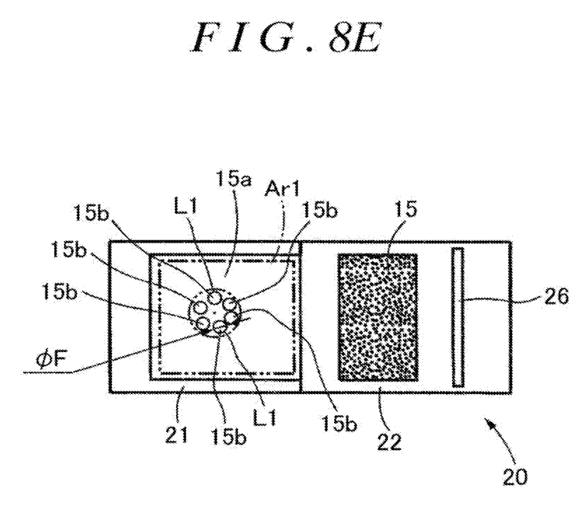

Thus, the preheating treatment is implemented by applying the short-wavelength laser beam L2 (assisting optical beam) with a fifth spot diameter φE at a fifth irradiation position P5 in the surface of the thin film layer 15a inside the irradiation area Ar1 as shown in FIG. 8A. The fifth spot diameter φE is a comparatively large diameter. Accordingly, at the fifth irradiation position P5, the short-wavelength laser beam L2 is applied at a lower power density than a power density at which the short-wavelength laser beam L2 is originally applicable. Then, the short-wavelength laser beam L2 heats the fifth irradiation position P5 to a temperature of 600° C. to 800° C., for example.

The surface temperature T at the fifth irradiation position P5 can be monitored, for example, with the non-contact infrared radiometer 39 (see FIG. 1). When it is confirmed that the fifth irradiation position P5 has reached a temperature of 600° C. to 800° C., for example, the preheating treatment is stopped.

Next, in the oxide film forming treatment step S20b (absorptance enhancement assisting step S20), the laser beam irradiation control section 49 controls the short-wavelength laser beam irradiation unit 46 and the near-infrared laser beam irradiation unit 47, and activates the assisting optical beam irradiation device 41 and the shaping optical beam irradiation device 30 at the same time. Thus, as shown in FIG. 8B, the short-wavelength laser beam L2 and the near-infrared laser beam L1 are overlappingly applied to the surface of the thin film layer 15a that has been preheated and kept hot.

Here, the irradiation position and the irradiation spot diameter of the short-wavelength laser beam L2 are the same as the irradiation position and the irradiation spot in the preheating treatment (fifth irradiation position P5 and fifth spot diameter φE). Accordingly, the short-wavelength laser beam L2 may be applied continuously from the preheating treatment.

A sixth spot diameter φF (equivalent to a fourth spot diameter φD) that is an irradiation spot diameter of the near-infrared laser beam L1 is a diameter smaller than the fifth spot diameter φE (equivalent to a third spot diameter φC). The near-infrared laser beam L1 is overlappingly applied at a predetermined position inside an area of the fifth spot diameter φE that is the irradiation area of the short-wavelength laser beam L2.

Here, the predetermined position is a position based on sliced data (rendered pattern) of the three-dimensionally shaped article to be produced, and is a position at which the three-dimensionally shaped article is to be formed. It goes without saying that the fifth irradiation position P5 that is the irradiation position at which the short-wavelength laser beam L2 is irradiated is also set based on the sliced data (rendered pattern) of the three-dimensionally shaped article to be produced.

The oxide film OM starts to form when the surface temperature T approaches the melting point of copper at the irradiation position in the surface of the thin film layer 15a at which the near-infrared laser beam L1 is applied so as to overlap the short-wavelength laser beam L2.

Next, in the film thickness calculation step S20c (absorptance enhancement assisting step S20), the film thickness estimation section 50 calculates a film thickness t of the oxide film OM formed on the surface of the thin film layer 15a. In the film thickness determination step S20d (absorptance enhancement assisting step S20), the treatment switching determination section 60 determines whether the film thickness t of the oxide film OM calculated in the film thickness calculation step S20c is within the predetermined range of the film thickness.

If the calculated film thickness t of the oxide film OM is within the predetermined range of the film thickness of B (nm) to A (nm), which is larger than zero and not larger than A (nm), irradiation of the near-infrared laser beam L1 at that position is stopped, and the process proceeds to the treatment switching determination step S20e. However, if the film thickness t is outside the range of B (nm) to A (nm), the program moves to the film thickness calculation step S20c, and the steps S20c and S20d are performed repeatedly until the film thickness t falls within the range of B (nm) to A (nm).

The range of B (nm) to A (nm) is a range of the film thickness corresponding to the absorptance of b % to a % in the graph of FIG. 6. The predetermined range of the film thickness may be set to any range that is larger than zero but not larger than A (nm). Here, as one example, the predetermined film thickness (B (nm) to A (nm)) may be set to a range of 5 nm to 85 nm corresponding to the absorptance of 10% (b %) to 60% (a %) as shown in the graph of FIG. 6. However, this set film thickness is given merely as an example, and the numerical values can be changed to desired ones. The value of A (nm) is also not limited to 85 nm. As shown in FIG. 5, the oxide film OM is formed on an outermost surface of each copper particle of the metal powder 15.

In the treatment switching determination step S20e (absorptance enhancement assisting step S20), if the treatment switching determination section 60 determines that all the plurality of oxide films OM to be formed on the thin film layer 15a have not been formed and any oxide film OM has yet to be formed, the program returns to the oxide film forming treatment step S20b. Then, the irradiation position of the near-infrared laser beam L1 is changed inside the irradiation area of the short-wavelength laser beam L2, and the formation treatment of the next oxide film OM is performed. This treatment is repeatedly performed to form the plurality of oxide films OM required to form the shaped article (at all the required positions) inside the irradiation area Ar1 (see FIG. 8C).

However, if the treatment switching determination section 60 determines in the treatment switching determination step S20e that the oxide films OM to be formed have been formed at all the required positions, the treatment switching determination section 60 switches the treatment from the oxide film forming treatment to the shaping treatment, and the program moves to the shaping step S30. Thus, in this embodiment, the absorptance enhancement assisting treatment is switched to the shaping treatment when it is determined that all the oxide films OM to be formed by overlapping irradiation of the short-wavelength laser beam L2 and the near-infrared laser beam L1 have been formed to the predetermined film thickness. In this way, the plurality of oxide films OM required to form the shaped article are formed with the sixth spot diameter φF, smaller than the fifth spot diameter φE, inside the area of the fifth spot diameter φE (see FIG. 8C).

As described above, the film thickness of the oxide film OM calculated in the film thickness calculation step S20c is estimated by the film thickness estimation section 50 (surface temperature measurement part 51, irradiation time measurement part 52, and oxide film thickness calculation part 53). As the actions of the film thickness estimation section 50 have been described above, detailed description thereof will be omitted.

In the shaping step S30 (shaping treatment), the shaping unit 70 included in the controller 45 activates the shaping optical beam irradiation device 30 to apply the near-infrared laser beam L1 (shaping optical beam) with the sixth spot diameter φF to the formation position of each oxide film OM in the surface of the thin film layer 15a as shown in FIG. 8D. Thus, the near-infrared laser beam L1 well heats the metal powder 15 of which the absorptance for the near-infrared laser beam L1 has been enhanced by the oxide film OM formed thereon.

After the metal powder 15 is melted in a short time, the metal powder 15 is solidified to form the thin film layer 15a as the solidified thin film layer 15b to additively shape the article. When the thin film layer 15a at all the formation positions of the oxide film OM has been formed as the solidified thin film layer 15b as shown in FIG. 8E, the program returns to the step S10. Then, the program is started over from formation of the next thin film layer 15a by the metal powder feeding device 20.

In the absorptance enhancement assisting step S20 of the above method, the program moves to the shaping step S30 after the oxide film OM of the predetermined film thickness is formed at a plurality of positions by overlapping irradiation of the short-wavelength laser beam L2 and the near-infrared laser beam L1. Then, in the shaping step S30, the solidified thin film layer 15b is formed by applying the near-infrared laser beam L1 to additively shape the article.

However, the method is not limited to this aspect. Alternatively, the program may move to the shaping step S30 according to determinations in the film thickness determination step S20d and the treatment switching determination step S20e, after the oxide film OM of the predetermined film thickness is formed at one position by overlapping irradiation of the short-wavelength laser beam L2 and the near-infrared laser beam L1 in the absorptance enhancement assisting step S20, and then, in the shaping step S30, the solidified thin film layer 15b may be formed by applying the near-infrared laser beam L1 to additively shape the article. In this case, as the absorptance enhancement assisting step S20 and the shaping step S30 are alternately performed multiple times, a plurality of solidified thin film layers 15b are formed.

In the first embodiment, the solidified thin film layer 15b is formed and the article is additively shaped by applying only the near-infrared laser beam L1 (shaping optical beam) in the shaping step S30. However, the method is not limited to this aspect. In a modified aspect of the first embodiment, in the shaping step S30, the near-infrared laser beam L1 may be applied so as to overlap the short-wavelength laser beam L2 as shown in FIG. 8B, with the short-wavelength laser beam L2 continuously applied from the absorptance enhancement assisting step S20. Thus, although a larger amount of energy is consumed than in the first embodiment, the solidified thin film layer 15b can be formed in a shorter time by the energy of the short-wavelength laser beam L2.

In the first embodiment, the preheating treatment on the surface of the thin film layer 15a is performed by applying only the short-wavelength laser beam L2 in the preheating treatment step S20a (absorptance enhancement assisting step S20). However, the method is not limited to this aspect. In Modified Example 1 of the first embodiment, the near-infrared laser beam L1 may be overlappingly applied in addition to the short-wavelength laser beam L2 as shown in FIG. 8B to perform the preheating treatment in the preheating treatment step S20a. In this case, although the irradiation area of the near-infrared laser beam L1 is smaller than the irradiation area of the short-wavelength laser beam L2, the preheating treatment on the thin film layer 15a is expected to be completed more quickly than in the first embodiment.

In the modified aspect of the first embodiment, as in Modified Example 1 of the first embodiment, the near-infrared laser beam L1 may be overlappingly applied in addition to the short-wavelength laser beam L2 as shown in FIG. 8B to perform the preheating treatment. This aspect will be referred to as Modified Example 2 of the first embodiment. In this case, too, preheating of the thin film layer 15a is expected to be completed more quickly than in the modified aspect of the first embodiment.

Next, a second embodiment will be described. A manufacturing apparatus 200 of the second embodiment shown in FIG. 1 is different from the manufacturing apparatus 100 of the first embodiment in that the absorptance enhancement assisting treatment by the absorptance enhancement assisting unit 40 does not include the preheating treatment. Moreover, the treatment of forming the oxide film OM (oxide film forming treatment) in the absorptance enhancement assisting treatment is partially different from that of the manufacturing apparatus 100 of the first embodiment.

Specifically, the manufacturing apparatus 100 of the first embodiment forms the oxide film OM in the oxide film forming treatment by applying the short-wavelength laser beam L2 (assisting optical beam) with the fifth spot diameter φE at the fifth irradiation position P5 inside the irradiation area Ar1 of the metal powder 15, and at the same time applying the near-infrared laser beam L1 (shaping optical beam) with the sixth spot diameter φF, smaller than the fifth spot diameter φE, so as to overlap the short-wavelength laser beam L2 (assisting optical beam).

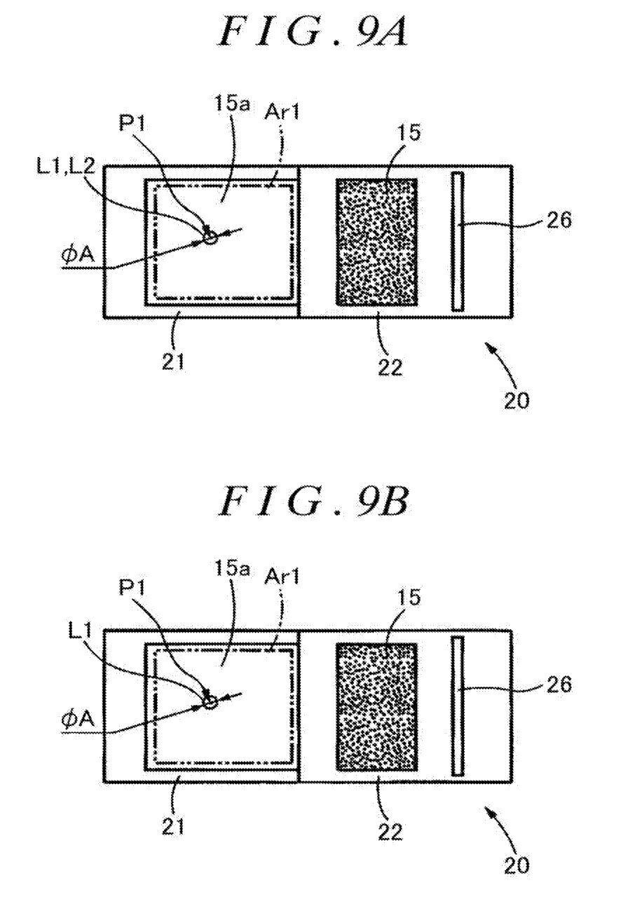

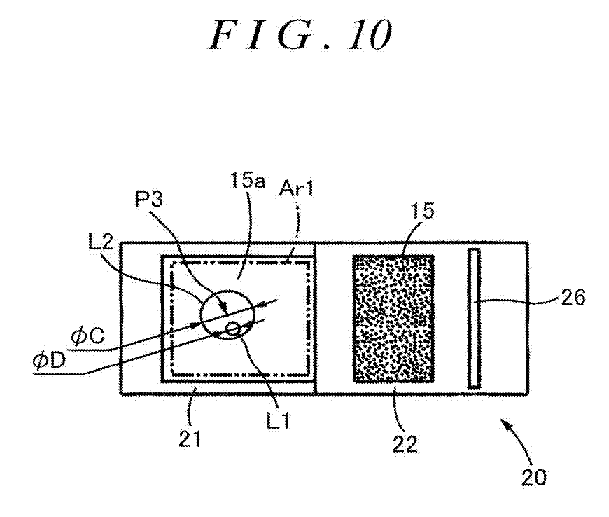

By contrast, the manufacturing apparatus 200 of the second embodiment forms the oxide film OM in the oxide film forming treatment by applying the short-wavelength laser beam L2 (assisting optical beam) with a first spot diameter φA at a first irradiation position P1 inside the irradiation area Ar1 of the metal powder 15, and at the same time applying the near-infrared laser beam L1 (shaping optical beam) with the first spot diameter φA at the first irradiation position P1 so as to overlap the short-wavelength laser beam L2 (assisting optical beam) as shown in FIG. 9A.

Thus, the short-wavelength laser beam L2 and the near-infrared laser beam L1 are applied with the same spot diameter, which is a major difference between the first embodiment and the second embodiment. Then, the shaping unit 70 implements (controls) the shaping treatment by applying the near-infrared laser beam L1 (shaping optical beam) with the first spot diameter φA at the first irradiation position P1 that is a formation position of the oxide film OM as shown in FIG. 9B. The shaping treatment by the shaping unit 70 is the same as in the first embodiment.

According to the second embodiment, the absorptance enhancement assisting treatment in the shaped article manufacturing apparatus 200 is the treatment of forming the oxide film OM on the surface of the metal powder 15, and the absorptance enhancement assisting unit 40 forms the oxide film OM by applying the short-wavelength laser beam L2 (assisting optical beam) with the first spot diameter φA at the first irradiation position P1 inside the irradiation area Ar1 of the metal powder 15, and at the same time applying the near-infrared laser beam L1 (shaping optical beam) with the first spot diameter φA at the first irradiation position P1 so as to overlap the short-wavelength laser beam L2 (assisting optical beam).

Thus, without the preheating treatment, the power level is raised in the absorptance enhancement assisting treatment by overlapping irradiation of the short-wavelength laser beam L2, having a high power density, and the near-infrared laser beam L1 applied with the same diameter, so that the oxide film OM can be formed efficiently in a short time.

In the second embodiment, the shaping treatment was performed by applying only the near-infrared laser beam L1 as in the first embodiment. However, the method is not limited to this aspect. Alternatively, the shaping treatment may be implemented, as with the absorptance enhancement assisting treatment (oxide film forming treatment), by applying the short-wavelength laser beam L2 (assisting optical beam) with the first spot diameter φA at the first irradiation position P1 inside the irradiation area Ar1 of the metal powder 15, and at the same time applying the near-infrared laser beam L1 (shaping optical beam) with the first spot diameter φA at the first irradiation position P1 so as to overlap the short-wavelength laser beam L2 (assisting optical beam) as shown in FIG. 9A. Thus, although the cost is increased, the shaping treatment can be completed in a short time.

In the second embodiment, the absorptance enhancement assisting treatment (oxide film forming treatment) is performed by applying the short-wavelength laser beam L2 (assisting optical beam) with the first spot diameter φA at the first irradiation position P1 inside the irradiation area Ar1 of the metal powder 15, and at the same time applying the near-infrared laser beam L1 (shaping optical beam) with the first spot diameter φA at the first irradiation position P1 so as to overlap the short-wavelength laser beam L2 (assisting optical beam). The shaping unit 70 implements the shaping treatment by applying the near-infrared laser beam L1 (shaping optical beam) with the first spot diameter φA at the first irradiation position P1 that is the formation position of the oxide film OM.

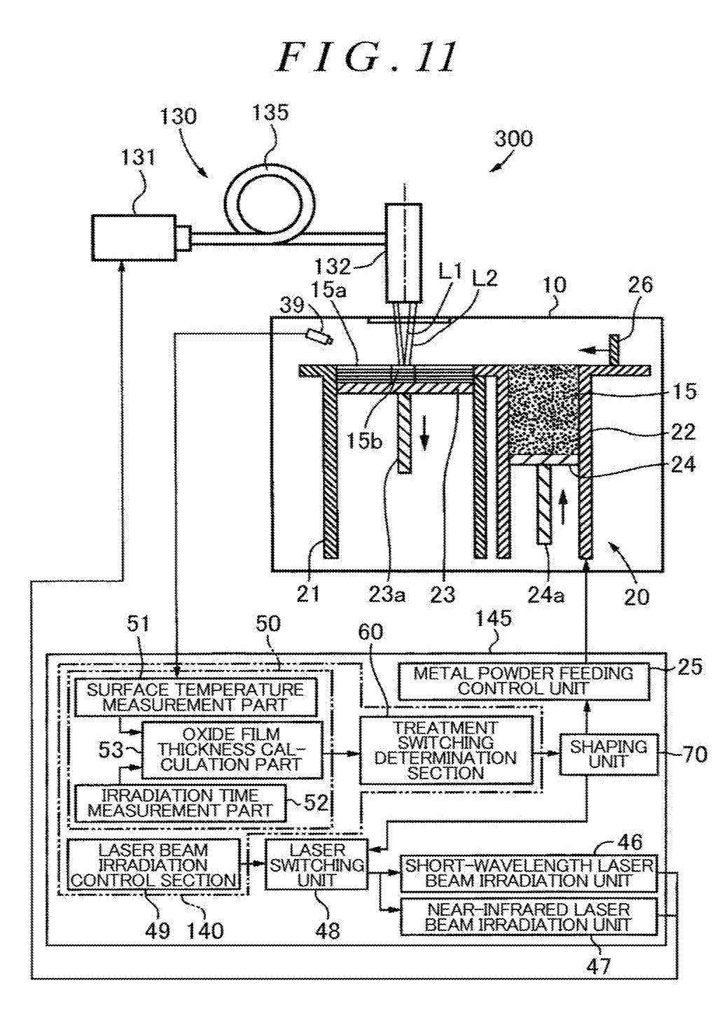

However, the method is not limited to this aspect In Modified Example 1 of the second embodiment, the absorptance enhancement assisting unit 40 may form the oxide film OM by applying the short-wavelength laser beam L2 (assisting optical beam) with the third spot diameter φC at a third irradiation position P3 inside the irradiation area Ar1 of the metal powder 15, and at the same time applying the near-infrared laser beam L1 (shaping optical beam) with the fourth spot diameter φD, smaller than the third spot diameter φC, so as to overlap the short-wavelength laser beam L2 (assisting optical beam) as shown in FIG. 10. In other words, the absorptance enhancement assisting unit 40 may apply the near-infrared laser beam L1 with a smaller area so as to overlap the short-wavelength laser beam L2 being applied to a larger area. Thus, as for irradiation of the short-wavelength laser beam L2, the irradiation contributes to formation of the oxide film without incurring a large cost.

In Modified Example 2 of the second embodiment, only the shaping unit 70 of Modified Example 1 of the second embodiment may be changed. Specifically, as with the absorptance enhancement assisting unit 40 of Modified Example 1 of the second embodiment, the shaping unit 70 may implement the shaping treatment by applying the short-wavelength laser beam L2 (assisting optical beam) with the third spot diameter φC at the third irradiation position P3 inside the irradiation area Ar1 of the metal powder 15, and at the same time applying the near-infrared laser beam L1 (shaping optical beam) with the fourth spot diameter φD, smaller than the third spot diameter φC, so as to overlap the short-wavelength laser beam L2 (assisting optical beam) as shown in FIG. 10. In other words, the shaping unit 70 may apply the near-infrared laser beam L1 with a smaller area so as to overlap the short-wavelength laser beam L2 being applied to a larger area. Thus, as for irradiation of the short-wavelength laser beam L2, the irradiation contributes to heating without incurring a large cost.

Next, a third embodiment will be described based on FIG. 11. A manufacturing apparatus 300 of the third embodiment is different from the manufacturing apparatus 100 of the first embodiment in terms of the shaping optical beam irradiation device 30. Specifically, in the third embodiment, the shaping optical beam irradiation device 30 and the assisting optical beam irradiation device 41 are integrated to constitute a shaping and assisting optical beams irradiation device 130. That is, the manufacturing apparatus 300 is configured so that the single shaping and assisting optical beams irradiation device 130 can apply both the near-infrared laser beam L1 (shaping optical beam) and the short-wavelength laser beam L2 (assisting optical beam) by switching therebetween. Accordingly, the shaping and assisting optical beams irradiation device 130 can be said to include the assisting optical beam irradiation device 41.

Thus, the manufacturing apparatus 300 includes the chamber 10, the metal powder feeding device 20, the shaping and assisting optical beams irradiation device 130, an absorptance enhancement assisting unit 140 (film thickness estimation section 50 and treatment switching determination section 60), and the shaping unit 70. The absorptance enhancement assisting unit 140 and the shaping unit 70 are provided in a controller 145 corresponding to the controller 45. Therefore, only differences from the manufacturing apparatus 100 of the first embodiment will be described, while description of the same parts will be omitted. The same components may be described while being denoted by the same reference signs.

The shaping and assisting optical beams irradiation device 130 applies the near-infrared laser beam L1 (shaping optical beam) or the short-wavelength laser beam L2 (assisting optical beam) to the surface of the thin film layer 15a of the metal powder 15 inside the chamber 10 that is fed to the irradiation area Ar1 by the metal powder feeding device 20. The near-infrared laser beam L1 and the short-wavelength laser beam L2 are switched under control of a laser switching unit 48 that is included in the controller 145. The shaping and assisting optical beams irradiation device 130 includes a laser oscillator 131 and a laser head 132. The laser oscillator 131 includes an optical fiber 135 that transmits the near-infrared laser beam L1 and the short-wavelength laser beam L2 oscillated by the laser oscillator 131 to the laser head 132.

As shown in FIG. 11, the laser head 132 is disposed at a predetermined distance from the surface of the thin film layer 15a of the metal powder 15 inside the chamber 10, with an axis of the laser head 132 perpendicular to that surface. As the laser head 132 has the same configuration as the laser head 32, description thereof will be omitted. The absorptance enhancement assisting unit 140 is a control unit that implements an absorptance enhancement assisting treatment using the short-wavelength laser beam L2 (assisting optical beam).

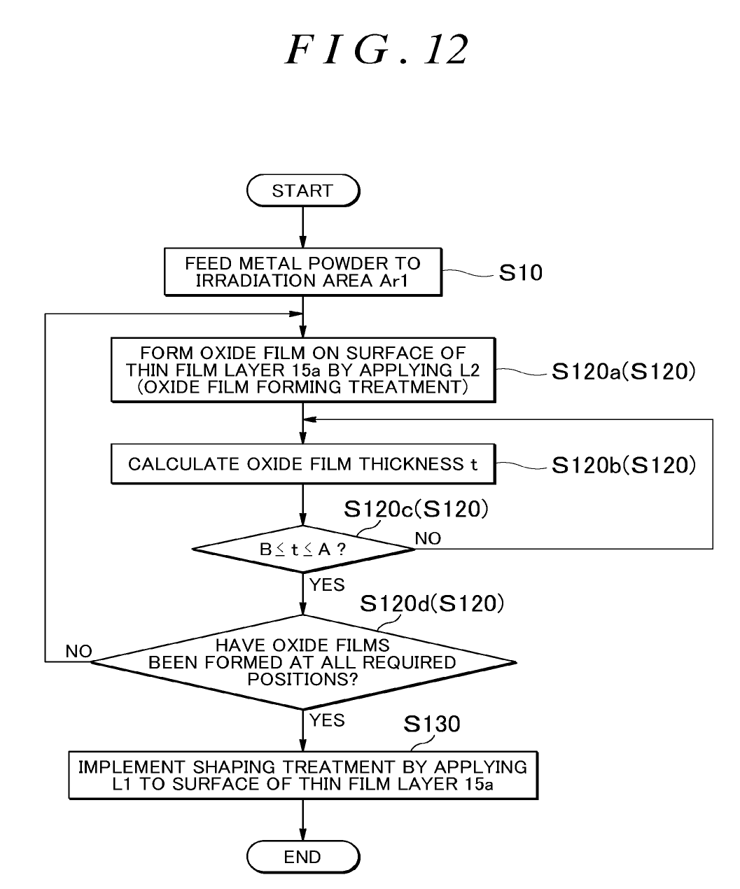

Next, a manufacturing method of additively shaping an article using the near-infrared laser beam L1 (shaping optical beam) will be described based on Flowchart 2 of FIG. 12. This shaped article manufacturing method includes the metal powder feeding step S10, an absorptance enhancement assisting step S120, and a shaping step S130. As the metal powder feeding step S10 is the same as in the other embodiments, description thereof will be omitted.

In the absorptance enhancement assisting step S120, a predetermined absorptance enhancement assisting treatment is performed on the metal powder 15 under control of the absorptance enhancement assisting unit 140 to enhance the absorptance of the near-infrared laser beam L1 (shaping optical beam) in the metal powder 15. The absorptance enhancement assisting step S120 includes an oxide film forming treatment step S120a, a film thickness calculation step S120b, a film thickness determination step S120c, and a treatment switching determination step S120d.

In the oxide film forming treatment step S120a (absorptance enhancement assisting step S120), the oxide film OM is formed by applying only the short-wavelength laser beam L2 (assisting optical beam) (oxide film forming treatment). In the oxide film forming treatment step S120a, therefore, the laser beam irradiation control section 49 controls the laser switching unit 48 and activates the short-wavelength laser beam irradiation unit 46. Accordingly, the short-wavelength laser beam irradiation unit 46 activates the shaping and assisting optical beams irradiation device 130 to apply the short-wavelength laser beam L2 to the surface of the thin film layer 15a.

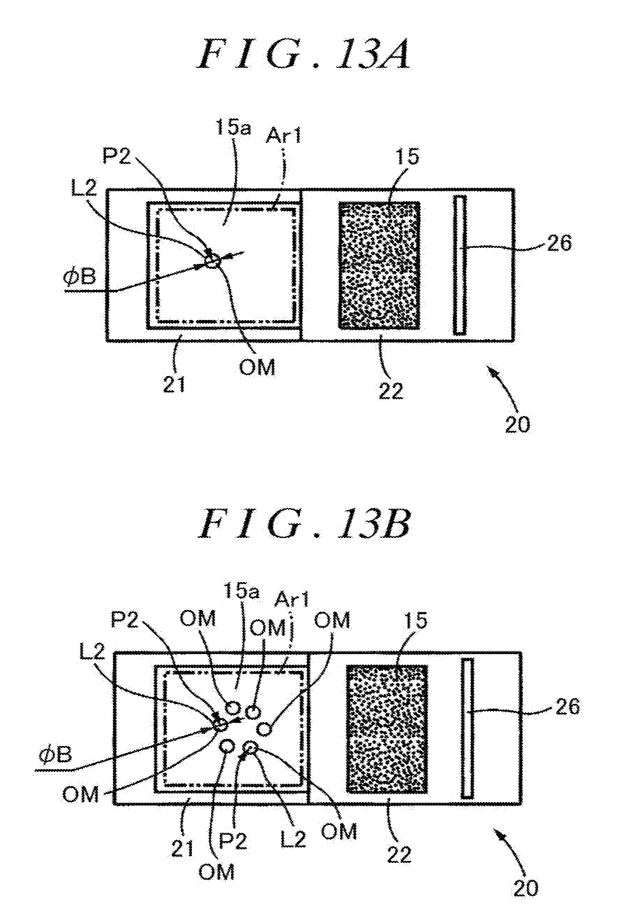

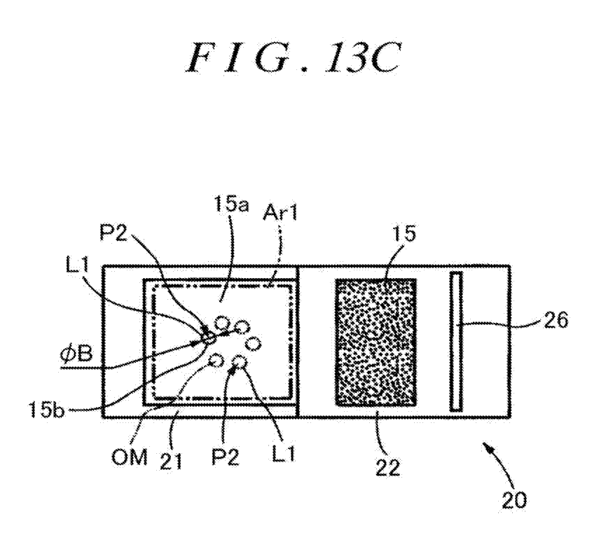

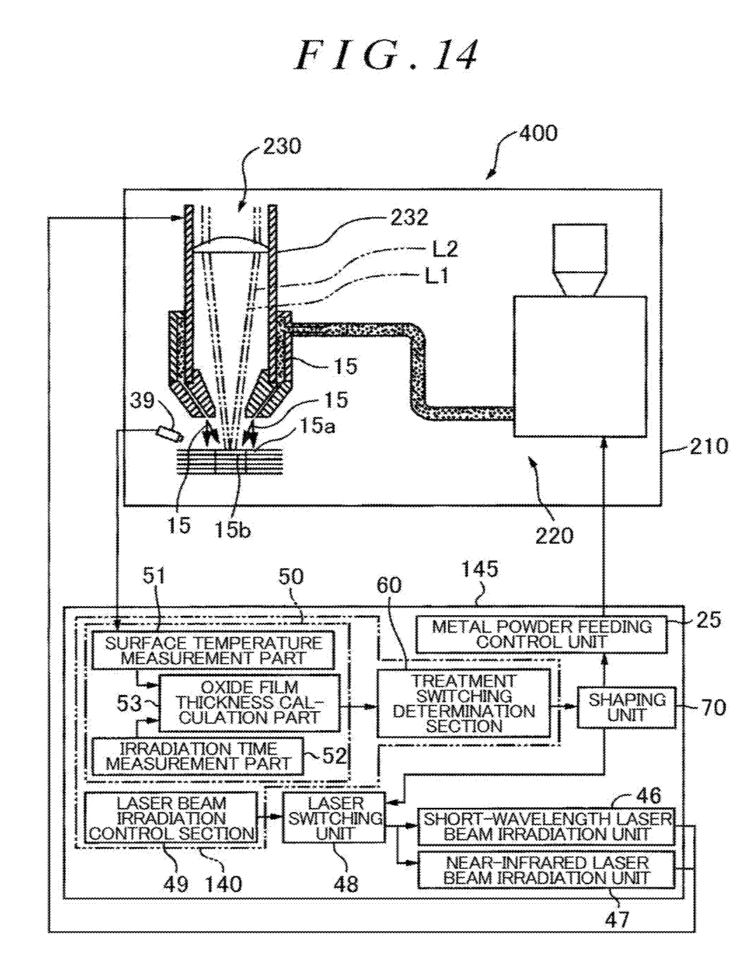

To form the oxide film OM, the short-wavelength laser beam L2 (assisting optical beam) is applied with a second spot diameter φB at a second irradiation position P2 in the surface of the thin film layer 15a inside the irradiation area Ar1 as shown in FIG. 13A. Here, the second spot diameter φB is a comparatively small spot diameter with which the short-wavelength laser beam L2 can independently form the oxide film OM on the surface of the thin film layer 15a In other words, the short-wavelength laser beam L2 is a laser beam with a high power density. The oxide film OM starts to form when the surface temperature T approaches the melting point of copper at the position irradiated with the short-wavelength laser beam L2 (assisting optical beam).

In the film thickness calculation step S120b (absorptance enhancement assisting step S120), the film thickness estimation section 50 calculates the film thickness t of the oxide film OM formed on the surface of the thin film layer 15a. In the film thickness determination step S120c (absorptance enhancement assisting step S120), the treatment switching determination section 60 determines whether the film thickness t of the oxide film OM calculated in the film thickness calculation step S120b is within the predetermined range of the film thickness.

If the calculated film thickness t of the oxide film OM is within the predetermined range of the film thickness, for example, the range of B (nm) to A (nm), irradiation of the near-infrared laser beam L1 at that position is stopped, and the program moves to the treatment switching determination step S120d. However, if the film thickness t is outside the range of B (nm) to A (nm), the program moves to the film thickness calculation step S120b, and the steps S120b and S120c are performed repeatedly until the film thickness t falls within the range of B (nm) to A (nm).

In the treatment switching determination step S120d (absorptance enhancement assisting step S120), if the treatment switching determination section 60 determines that all the plurality of oxide films OM to be formed on the thin film layer 15a (at all the required positions) are not formed and that any oxide film OM has yet to be formed, the program returns to the oxide film forming treatment step S120a. Then, the irradiation position of the short-wavelength laser beam L2 is changed, and the forming treatment of the next oxide film OM not yet formed is performed. This treatment is performed repeatedly until all the oxide films OM required to form a shaped article are formed inside the irradiation area Ar1 (see FIG. 13B).

However, if it is determined in the treatment switching determination step S120d that the oxide films OM to be formed have been formed at all the required positions, the treatment switching determination section 60 switches the treatment from the oxide film forming treatment to the shaping treatment, causing the program to move to the shaping step S130. Thus, in this embodiment, the absorptance enhancement assisting treatment is switched to the shaping treatment if it is determined that all the oxide films OM to be formed have been formed to the predetermined film thickness by irradiation of the short-wavelength laser beam L2.

In the shaping step S130, the shaping unit 70 included in the controller 145 controls the laser switching unit 48 to activate the shaping and assisting optical beams irradiation device 130. Thus, the near-infrared laser beam L1 (shaping optical beam) is applied with the second spot diameter φB at the formation position of each oxide film OM in the surface of the thin film layer 15a as indicated by the solid-line circle in FIG. 13C.

Accordingly, the metal powder 15 of which the absorptance for the near-infrared laser beam L1 has been enhanced by the oxide film OM formed thereon is well heated by the near-infrared laser beam L1 to melt in a short time. Then, the thin film layer 15a is solidified and formed as the solidified thin film layer 15b to additively shape the article. The program returns to the step S10 when the thin film layer 15a has been formed as the solidified thin film layer 15b at all the formation positions of the oxide film OM indicated by the two-dot dashed-line circles in FIG. 13C. Then, the program is started over from formation of the next thin film layer 15a by the metal powder feeding device 20.

Thus, the third embodiment can manufacture articles inexpensively, as the near-infrared laser beam L1 (shaping optical beam) and the short-wavelength laser beam L2 (assisting optical beam) can be applied by the single shaping and assisting optical beams irradiation device 130 included in the manufacturing apparatus.

As a fourth embodiment, the present disclosure is also applicable to a manufacturing apparatus 400 of a type disclosed in Japanese Patent Application Publication No. 2007-216235 that has a configuration different from that of the manufacturing apparatuses 100 to 300 of the first to third embodiments (see FIG. 14). The manufacturing apparatus 400 is different from the manufacturing apparatuses 100 to 300 of the first to third embodiments in terms of the metal powder feeding device 20, the shaping optical beam irradiation device 30, and the shaping and assisting optical beams irradiation device 130. Among these devices, especially the metal powder feeding device 20 has a different aspect.

The manufacturing apparatus 400 applies the near-infrared laser beam L1 (shaping optical beam) and the short-wavelength laser beam L2 (assisting optical beam) while switching a single shaping and assisting optical beams irradiation device 230 under control of the laser switching unit 48. Thus, as in the third embodiment, the manufacturing apparatus 400 can be said to include the assisting optical beam irradiation device 41.

In addition, the manufacturing apparatus 400 includes a metal powder feeding device 220, corresponding to the metal powder feeding device 20, integrally on an outer peripheral side of a laser head 232 that emits a laser beam. Moreover, in the manufacturing apparatus 400, the metal powder feeding device 220 and the laser head 232 are disposed inside a chamber 210. As this type of manufacturing apparatus is publicly known, detailed description thereof will be omitted.

Thus, the manufacturing apparatus 400 jets the metal powder 15 from an outer peripheral portion of the laser head 232 into the irradiation area Ar1 by the metal powder feeding device 220, and then performs the oxide film forming treatment (absorptance enhancement assisting treatment) by applying the short-wavelength laser beam L2 (assisting optical beam) from the shaping and assisting optical beams irradiation device 230 to form the oxide film OM (not shown in FIG. 14) on the surface of the thin film layer 15a. Then, after the oxide film OM is formed, the laser switching unit 48 of the controller 145 switches the laser irradiation of the shaping and assisting optical beams irradiation device 230 from the short-wavelength laser beam L2 to the near-infrared laser beam L1 (shaping optical beam).

Thus, the shaping treatment is performed by applying the near-infrared laser beam L1 from the shaping and assisting optical beams irradiation device 230 at the formation position of the oxide film OM to form the three-dimensionally shaped article. The absorptance enhancement assisting step and the shaping step are the same as the absorptance enhancement assisting step S120 and the shaping step S130 of the second embodiment. In this way, the manufacturing apparatus 400 can also form a three-dimensionally shaped article similar to the shaped article manufactured by the manufacturing apparatus 300 of the third embodiment.

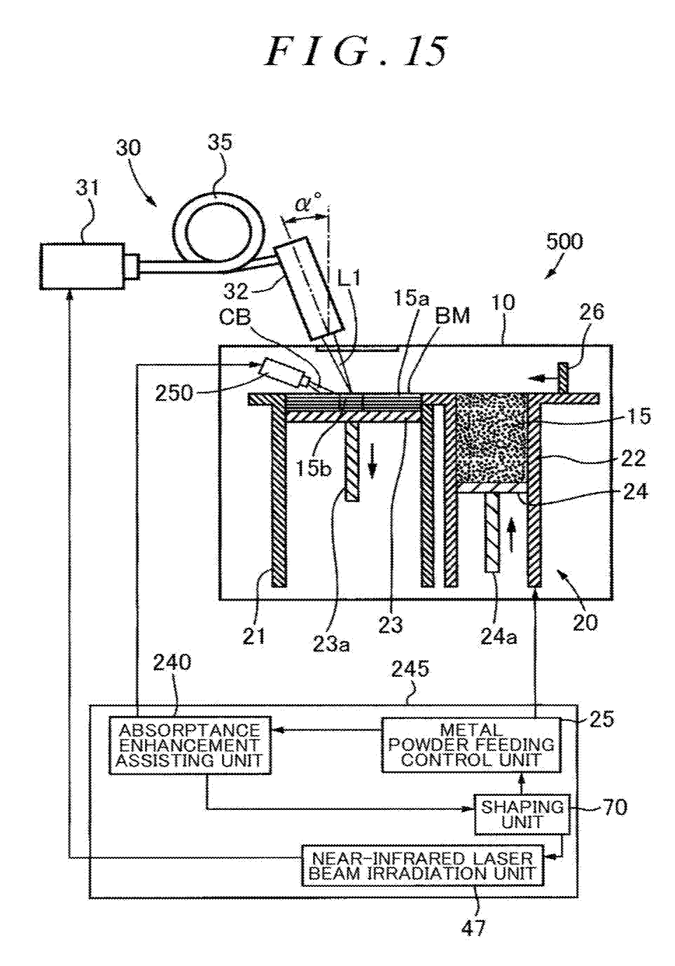

Next, a fifth embodiment will be described based on FIG. 15. Compared with the manufacturing apparatus 100 of the first embodiment, a manufacturing apparatus 500 of the fifth embodiment shown in FIG. 15 does not have the assisting optical beam irradiation device 41. That is, the manufacturing apparatus 500 is an apparatus that applies only the near-infrared laser beam L1 (shaping optical beam) by the shaping optical beam irradiation device 30. In the following, only differences from the manufacturing apparatus 100 of the first embodiment will be mainly described, while description of the same parts will be omitted. The same components may be described while being denoted by the same reference signs.

The manufacturing apparatus 500 includes the chamber 10, the metal powder feeding device 20, the shaping optical beam irradiation device 30, a black coating forming device 250, and a controller 245 corresponding to the controller 45 of the first embodiment. The controller 245 includes the metal powder feeding control unit 25, an absorptance enhancement assisting unit 240, the near-infrared laser beam irradiation unit 47, and the shaping unit 70.

The absorptance enhancement assisting unit 240 performs a predetermined absorptance enhancement assisting treatment on the surface of the metal powder 15 fed to the irradiation area Ar1. Here, the predetermined absorptance enhancement assisting treatment is a treatment of forming a black coating BM by attaching a black material, to be described later, to the surface of the metal powder 15 after the metal powder 15 is fed to the irradiation area Ar1.

The black coating forming device 250 is provided inside the chamber 10. The black coating forming device 250 is controlled by the absorptance enhancement assisting unit 240 included in the controller 245. As the predetermined absorptance enhancement assisting treatment, the black coating forming device 250 jets and attaches carbon black CB, which is one example of the black material, to the surface of the thin film layer 15a of the metal powder 15 that has been fed to the irradiation area Ar1 by the metal powder feeding device 20.

The black coating forming device 250 may have any configuration, provided that the black coating forming device 250 can jet and spray the carbon black CB (black material) stored inside a storage container (not shown) onto the entire surface of the thin film layer 15a. The carbon black CB is carbon microparticles that are industrially manufactured under quality control, and is a publicly-known material used in many fields including inks and tires. Therefore, more detailed description of the carbon black CB will be omitted. The carbon black CB is thinly attached to the surface of the thin film layer 15a of the metal powder 15 (copper particles), fed to the irradiation area Ar1, to form the black coating BM.

In this embodiment, as its name suggests, the black material is a material formed in black, and is a material having a high absorptance for the near-infrared laser beam L1 (shaping optical beam). Examples of the black material include, other than the carbon black CB, graphite, coal, and black paint (black ink). The definition of the black color for the black material is not strict; the black color may be any color that is usually recognized as black, such as the color of graphite, coal, or black paint (black ink) mentioned above.

Following implementation of the absorptance enhancement assisting treatment (formation of the black coating BM), the shaping unit 70 activates the shaping optical beam irradiation device 30 by the near-infrared laser beam irradiation unit 47 to apply the near-infrared laser beam L1 (shaping optical beam) at a predetermined position that is set in the surface of the thin film layer 15a. Here, the predetermined position is a position based on sliced data (rendered pattern) for the three-dimensionally shaped article to be produced. Thus, the shaping unit 70 performs a shaping treatment of additively shaping the article by heating the surface of the thin film layer 15a on which the black coating BM is formed, and thereby melting and then solidifying the thin film layer 15a.

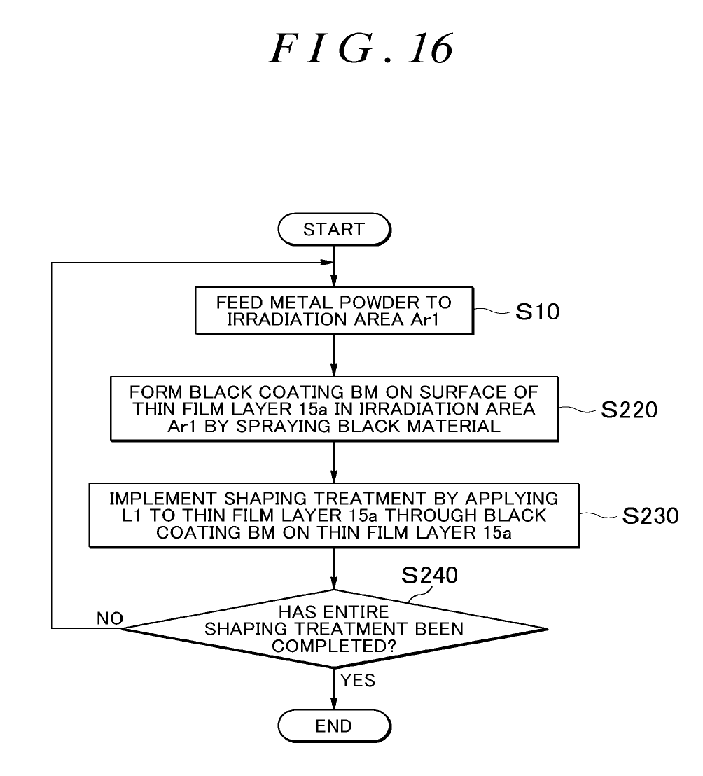

Next, a shaped article manufacturing method in the fifth embodiment will be described based on Flowchart 3 of FIG. 16. The shaped article manufacturing method includes the metal powder feeding step S10, an absorptance enhancement assisting step S220, a shaping step S230, and a shaping completion confirmation step S240. The metal powder feeding step S10 is the same as in Flowchart 1. In the following, differences from Flowchart 1 of the first embodiment will be mainly described.

In the absorptance enhancement assisting step S220, the black coating forming device 250 forms the black coating BM under control of the absorptance enhancement assisting unit 240 by jetting and attaching the carbon black CB to the entire surface of the thin film layer 15a of the metal powder 15 having been fed to the irradiation area Ar1. The thickness of the black coating BM may be approximately several μm to a dozen or so μm. However, the thickness is not limited to this example.

The black coating BM efficiently absorbs the near-infrared laser beam L1 and rises rapidly in temperature. As the black coating BM itself rises in temperature, the metal powder 15 to which the black coating BM is attached also rises in temperature rapidly by heat conduction and is kept hot by heat conduction. Thus, the black coating BM assists in raising the temperature of the metal powder 15. Therefore, as in the embodiments in which the oxide film OM is formed, formation of the black coating BM can be said to enhance the absorptance of the near-infrared laser beam L1 in the metal powder 15 (copper powder).

In the shaping step S230 (shaping treatment), the shaping unit 70 of the controller 245 activates the shaping optical beam irradiation device 30 to apply the near-infrared laser beam L1 with a predetermined irradiation diameter at a predetermined irradiation position in the surface of the thin film layer 15a (not shown).

When the near-infrared laser beam L1 (shaping optical beam) is applied to the black coating BM formed on the surface of the thin film layer 15a, the temperature of the black coating BM rises rapidly as described above. Accordingly, the black coating BM causes a rapid increase in temperature of the metal powder 15 in contact with the black coating BM by heat conduction and keeps the metal powder 15 hot.

Thereafter, when the raised temperature of the thin film layer 15a exceeds the melting point (e.g., 1060° C.), the thin film layer 15a is melted and joined to the solidified thin film layer 15b underneath the thin film layer 15a, so that the article is additively shaped. Here, by the time the metal powder 15 melts, the black coating BM (carbon black CB) has already been vaporized and therefore does not mix into the melted metal powder 15.

Here, vaporization of the black coating BM (carbon black CB) will be briefly described. The vaporization temperature of the carbon black CB (black coating BM) is higher than the melting point of the copper particles (metal powder 15). However, the carbon black (black coating BM) is attached only thinly to the surface of the thin film layer 15a. Accordingly, the volume, i.e., heat capacity, of the black coating BM in a portion irradiated with the near-infrared laser beam L1 is small. Thus, applying the near-infrared laser beam L1 to the black coating BM allows the black coating BM to reach the vaporization temperature before the metal powder 15 reaches the melting point. In the shaping treatment, therefore, the black coating BM (carbon black CB) vaporizes before the metal powder 15 melts, and does not mix into the metal powder 15.

After the metal powder 15 is melted in a short time by this process, the thin film layer 15a is solidified and formed as the solidified thin film layer 15b to additively shape the article. When the near-infrared laser beam L1 has been applied to all the predetermined irradiation positions in the surface of one thin film layer 15a based on the sliced data, the program proceeds to the shaping completion confirmation step S240.

In the shaping completion confirmation step S240, it is confirmed whether all the plurality of thin film layers 15a that are set in advance to be additively shaped have been additively shaped. If it is determined in the shaping completion confirmation step S240 that any thin film layer 15a has yet to be additively shaped, the program returns to the metal powder feeding step S10. Then, the program is started over from formation of the next thin film layer 15a by the metal powder feeding device 20.

Subsequently, each time the thin film layer 15a is fed to the irradiation area Ar1 by the metal powder feeding device 20, the black coating BM is formed on the surface of the metal powder 15 under control of the absorptance enhancement assisting unit 240. Repeating these treatments can form a three-dimensionally shaped article in a shorter time than is conventionally possible. If it is determined in the shaping completion confirmation step S240 that all the plurality of thin film layers 15a have been additively shaped as planned, the program is ended.

In the fifth embodiment, the black coating BM is formed over the entire surface of the thin film layer 15a of the metal powder 15 having been fed to the irradiation area Ar1 in the absorptance enhancement assisting step S220. However, the method is not limited to this aspect. The area of the black coating BM formed on the surface of the thin film layer 15a may be only an area corresponding to the predetermined irradiation position in the surface of the thin film layer 15a of the metal powder 15 at which the shaping unit 70 applies the near-infrared laser beam L1 (shaping optical beam) to perform the shaping treatment. Thus, the black coating BM is not formed in other areas where the near-infrared laser beam L1 (shaping optical beam) is not applied, so that the amount of carbon black CB used can be reduced for cost reduction.

In the fifth embodiment, after all the thin film layers 15a are fed to the irradiation area Ar1, the carbon black CB is jetted to the surface of the thin film layer 15a to form the black coating BM. However, the method is not limited to this aspect. The black coating BM may be formed at a timing following, with a little delay, the timing of feeding of the thin film layer 15a of the metal powder 15 to the irradiation area Ar1. In this way, similar effects can be achieved.

In the fifth embodiment, the carbon black CB is jetted to the surface of the thin film layer 15a of the metal powder 15 having been fed to the irradiation area Ar1 to form the black coating BM. However, the method is not limited to this aspect. In another modified aspect, the black coating BM may be produced as follows by an absorptance enhancement assisting treatment performed by the absorptance enhancement assisting unit 240.

Specifically, the carbon black CB is mixed and stirred in a raw material of the metal powder 15 (corresponding to an aggregate of metal particles) before the metal powder 15 is fed to the irradiation area Ar1. Thus, the carbon black CB is attached to the surface of each raw material metal particle to produce the raw material (aggregate of metal particles) with the black coating BM attached thereto.

In this case, a predetermined amount of carbon black CB can be input into a container in which the raw material of the metal powder 15 is stored, and the mixture can be stirred manually or mechanically (not shown). Thereafter, when the raw material metal particles with the carbon black CB attached to the entire outer surface are fed to the irradiation area Ar1 by the metal powder feeding device 20, the carbon black CB is already reliably attached to, i.e., the black coating BM is already formed on, the surface of the metal powder 15 fed to the irradiation area Ar1. Thus, effects similar to those of the fifth embodiment can be achieved.

As is clear from the above, according to the first to fifth embodiments, the manufacturing apparatuses 100 to 500 of the shaped article are manufacturing apparatuses 100 to 500 that additively shape an article by sintering or melting and then solidifying the metal powder 15 through irradiation of the near-infrared laser beam L1 (shaping optical beam). The manufacturing apparatus 100 (to 500) includes: the chamber 10 (210) capable of isolating inside air from outside air; the metal powder feeding device 20 (220) that is provided inside the chamber 10 (210) and feeds the metal powder 15 to the irradiation area Ar1 of the near-infrared laser beam L1 (shaping optical beam); the shaping optical beam irradiation device 30 (shaping and assisting optical beams irradiation devices 130, 230) that applies the near-infrared laser beam L1 (shaping optical beam) to the surface of the metal powder 15 (thin film layer 15a) inside the chambers 10 (210) fed to the irradiation area Ar1; the absorptance enhancement assisting unit 40 (140, 240) that performs the predetermined absorptance enhancement assisting treatment on the metal powder 15 (thin film layer 15a) to enhance the absorptance of the near-infrared laser beam L1 (shaping optical beam) in the metal powder 15 (thin film layer 15a) to be irradiated therewith; and the shaping unit 70 that, following implementation of the absorptance enhancement assisting treatment, performs the shaping treatment of additively shaping the article by applying the near-infrared laser beam L1 (shaping optical beam) to the metal powder 15 (thin film layer 15a) fed to the irradiation area Ar1, and thus heating the metal powder 15 (thin film layer 15a) to sinter or melt and then solidify.

Thus, the manufacturing apparatus 100 (to 500) of the shaped article performs the absorptance enhancement assisting treatment for enhancing the absorptance of the near-infrared laser beam L1 (shaping optical beam) in the metal powder 15 (thin film layer 15a) by the absorptance enhancement assisting unit 40 (140, 240), and thereafter applies the near-infrared laser beam L1 (shaping optical beam) to the metal powder 15 (thin film layer 15a). As a result, the near-infrared laser beam L1 is well absorbed by the metal powder 15 (thin film layer 15a). Accordingly, the metal powder 15 (thin film layer 15a) is well heated by short-time irradiation of the near-infrared laser beam L1 to sinter or melt and then solidify, so that time required for additive shaping can be reduced and articles can be produced at low cost.

According to the above embodiments, the manufacturing apparatuses 100 to 300 of the shaped article according to the first to third embodiments include (or can be regarded to include) the assisting optical beam irradiation device 41 that applies the short-wavelength laser beam L2 (assisting optical beam) having a wavelength different from the wavelength of the near-infrared laser beam L1 (shaping optical beam) to the metal powder 15 (thin film layer 15a). The absorptance enhancement assisting units 40, 140 implement the absorptance enhancement assisting treatment using at least the short-wavelength laser beam L2 (assisting optical beam), and the shaping unit 70 implements the shaping treatment using at least the near-infrared laser beam L1 (shaping optical beam).

The short-wavelength laser beam L2 (assisting optical beam) takes high operating cost, but has a good absorptance in the metal powder 15. Thus, for the preheating treatment and the oxide film forming treatment in the absorptance enhancement assisting treatment that do not require high power level, the short-wavelength laser beam L2 can be applied at low power level, so that these treatments can be implemented comparatively inexpensively. As the shaping treatment is performed using the near-infrared laser beam L1 (shaping optical beam) that takes low operating cost, on the metal powder 15 of which the absorptance has been enhanced by the absorptance enhancement assisting treatment, this treatment can also be implemented inexpensively. Thus, both the absorptance enhancement assisting treatment and the shaping treatment can be inexpensively implemented by taking advantage of the individual characteristics of the laser beams L1, L2.

According to the modified aspect of the first embodiment, Modified Example 2 of the first embodiment, and the modified aspect and Modified Example 2 of the second embodiment, the shaping unit 70 implements the shaping treatment using both the near-infrared laser beam L1 (shaping optical beam) and the short-wavelength laser beam L2 (assisting optical beam). Thus, the shaping treatment can be implemented in a short time.

According to the first and second embodiments, the absorptance enhancement assisting units 40, 140 implement the absorptance enhancement assisting treatment using both the near-infrared laser beam L1 (shaping optical beam) and the short-wavelength laser beam L2 (assisting optical beam). Thus, the absorptance enhancement assisting treatment can be implemented in a short time.

According to the first embodiment, the absorptance enhancement assisting treatment is the treatment of forming the oxide film OM on the surface of the metal powder 15 (thin film layer 15a). The absorptance enhancement assisting unit 40 forms the oxide film OM by applying the short-wavelength laser beam L2 (assisting optical beam) with the third spot diameter φC at the third irradiation position P3 inside the irradiation area Ar1 of the metal powder 15 (thin film layer 15a), and at the same time applying the near-infrared laser beam L1 (shaping optical beam) with the fourth spot diameter φD, smaller than the third spot diameter φC, so as to overlap the assisting optical beam. Then, the shaping unit 70 implements the shaping treatment by applying at least the near-infrared laser beam L1 (shaping optical beam) with the fourth spot diameter φD at the formation position of the oxide film OM.

Thus, to form the oxide film OM, the short-wavelength laser beam L2 (assisting optical beam) applied to a larger area (third spot diameter φC) is applied, and at the same time the near-infrared laser beam L1 (shaping optical beam) is applied to a smaller area (fourth spot diameter φD) than the short-wavelength laser beam L2 so as to overlap the short-wavelength laser beam L2. As a result, the power level becomes high in an overlapping area. Accordingly, the oxide film OM can be formed in a short time.

According to the first embodiment, the absorptance enhancement assisting treatment is the treatment of preheating the metal powder 15 (thin film layer 15a) and forming the oxide film OM on the surface of the preheated metal powder 15 (thin film layer 15a). The absorptance enhancement assisting unit 40 implements the preheating treatment by applying at least the short-wavelength laser beam L2 (assisting optical beam) with the fifth spot diameter φE at the fifth irradiation position P5 inside the irradiation area Ar1 of the metal powder 15 before applying the near-infrared laser beam L1 (shaping optical beam). Thereafter, the absorptance enhancement assisting unit 40 forms the oxide film OM by applying the short-wavelength laser beam L2 (assisting optical beam) with the fifth spot diameter φE at the fifth irradiation position P5 inside the irradiation area Ar1 of the metal powder 15, and at the same time applying the near-infrared laser beam L1 (shaping optical beam) with the sixth spot diameter φF, smaller than the fifth spot diameter φE, so as to overlap the short-wavelength laser beam L2 (assisting optical beam). The shaping unit 70 implements the shaping treatment by applying at least the near-infrared laser beam L1 (shaping optical beam) with the sixth spot diameter φF at the formation position of the oxide film OM.

Thus, the absorptance enhancement assisting treatment involves preheating the metal powder 15 (thin film layer 15a) and then forming the oxide film OM on the surface of the preheated metal powder 15 (thin film layer 15a). Thus, time taken to form the oxide film OM can be reduced. To form the oxide film OM, the short-wavelength laser beam L2 applied to a larger area (fifth spot diameter φE) is applied, and at the same time the near-infrared laser beam L1 (shaping optical beam) is applied to a smaller area (sixth spot diameter φF) than the short-wavelength laser beam L2 so as to overlap the short-wavelength laser beam L2 (assisting optical beam). As a result, the power level becomes high in an overlapping area. Thus, the oxide film OM can be formed in a short time.

According to the first embodiment and the modified aspect of the first embodiment, the absorptance enhancement assisting unit 40 implements the preheating treatment using the short-wavelength laser beam L2 (assisting optical beam), without using the near-infrared laser beam L1 (shaping optical beam). Thus, it is possible to implement the preheating treatment at lower cost with almost no increase in amount of time required by not using the near-infrared laser beam L1 that has a low absorptance in the metal powder 15.

According to the first to fourth embodiments, in relation to the film thickness of the oxide film OM, the absorptance of the near-infrared laser beam L1 (shaping optical beam) in the metal powder 15 has the periodicity of a maximum value and a minimum value appearing alternately as the film thickness changes in the plus direction, and has such a characteristic that the absorptance becomes lowest when the film thickness of the oxide film OM is zero. The absorptance enhancement assisting units 40, 140 set the predetermined film thickness of the oxide film OM having a thickness exceeding zero to be within such a range that, in relation to the absorptance having that periodicity, the film thickness of the oxide film OM is larger than zero but not larger than the first maximum film thickness A corresponding to the first maximum value a that is the maximum value of the absorptance appearing first. Thus, the absorptance of the near-infrared laser beam L1 (shaping optical beam) is reliably enhanced compared with if the near-infrared laser beam L1 is absorbed by the metal powder without the oxide film OM formed thereon.

According to the first to fourth embodiments, the absorptance enhancement assisting units 40, 140 include the film thickness estimation section 50 that estimates the film thickness of the oxide film OM formed on the surface of the metal powder 15 (thin film layer 15a) by the absorptance enhancement assisting treatment, and the treatment switching determination section 60 that determines whether the estimated film thickness of the oxide film OM has reached the predetermined film thickness, and, upon determining that the predetermined film thickness has been reached, switches the absorptance enhancement assisting treatment to the shaping treatment by the shaping unit 70.

The film thickness estimation section 50 includes: the surface temperature measurement part 51 that measures the surface temperature T of the thin film layer 15a of the metal powder 15 on which the oxide film OM is formed; the irradiation time measurement part 52 that measures the irradiation time H for which the short-wavelength laser beam L2 (assisting optical beam) is applied, or the short-wavelength laser beam L2 (assisting optical beam) and near-infrared laser beam L1 (shaping optical beam) are overlappingly applied, to the surface of the thin film layer 15a of the metal powder 15 to form the oxide film OM; and the oxide film thickness calculation part 53 that calculates the estimated film thickness of the oxide film OM based on the measured surface temperature T and the measured irradiation time H. Thus, the film thickness of the oxide film OM can be accurately estimated, so that a desired absorptance enhancing effect can be favorably achieved.

According to the first to fourth embodiments, the shaping optical beam is the laser beam (near-infrared laser beam L1) with a near-infrared wavelength, and the assisting optical beam is the laser beam (short-wavelength laser beam L2) with a wavelength shorter than the near-infrared wavelength. Accordingly, the short-wavelength laser beam L2 with a short wavelength that takes high operating cost but has a good absorptance is mainly used for the absorptance enhancement assisting treatment in which the thin film layer 15a of the metal powder 15 need not be heated to a high temperature, while the near-infrared laser beam L1 with a near-infrared wavelength that takes low operating cost is used for the shaping treatment in which the thin film layer 15a of the metal powder 15 need be heated to a high temperature. Thus, these treatments can be implemented at low cost.

According to the first to fifth embodiments, the metal powder 15 is a copper powder. Thus, copper particles that are in high market demand can be used to manufacture a three-dimensionally shaped article by metal AM.

According to the fifth embodiment, the absorptance enhancement assisting treatment is the treatment of forming the black coating BM by attaching the black material to the surface of the metal powder 15 fed to the irradiation area Ar1 by the metal powder feeding device 20. The absorptance enhancement assisting unit 240 forms the black coating BM on the surface of the metal powder 15 fed to the irradiation area Ar1 by the absorptance enhancement assisting treatment that is performed before the metal powder 15 is fed to the irradiation area Ar1 or after the metal powder 15 is fed to the irradiation area Ar1. Thus, the irradiation time of the shaping optical beam can be reduced, so that the absorptance enhancement assisting treatment can be implemented in a short time for cost reduction.

According to the fifth embodiment, when, following implementation of the absorptance enhancement assisting treatment, the shaping unit 70 applies the near-infrared laser beam L1 (shaping optical beam) to the surface of the metal powder 15 and thus heats the metal powder 15 to sinter or melt and then solidify, the black coating BM does not remain inside the shaped article that has been solidified and additively shaped. Thus, the shaped article has higher strength and improved quality as a product.

According to the fifth embodiment, the absorptance enhancement assisting unit 240 includes the black coating forming device 250 that is provided inside the chamber 10 and forms the black coating BM on the surface of the metal powder 15 after the metal powder 15 is fed to the irradiation area Ar1. Thus, the black coating BM is formed after the metal powder 15 is fed to the irradiation area Ar1, so that no extra black coating BM is attached to outside the surface of the thin film layer 15a of the metal powder 15 and waste is reduced.

According to the fifth embodiment, the area of the surface of the metal powder 15 in which the absorptance enhancement assisting unit 240 forms the black coating BM is the area corresponding to the predetermined irradiation position in the surface of the metal powder 15 at which the shaping unit 70 applies the near-infrared laser beam L1 (shaping optical beam) to perform the shaping treatment following implementation of the absorptance enhancement assisting treatment. Thus, it is not necessary to attach the black coating BM to the entire surface of the thin film layer 15a in the irradiation area Ar1 of the metal powder 15, so that waste is further reduced.

According to the fifth embodiment, each time the metal powder 15 is fed to the irradiation area Ar1 by the metal powder feeding device 20, the black coating BM is formed on the surface of the metal powder 15 by the absorptance enhancement assisting unit 240. Thus, each time the metal powder 15 is fed to the irradiation area Ar1, the article is additively shaped in a short time, so that the three-dimensionally shaped article that is the finished article can be produced in a short time.

According to the modified aspect of the fifth embodiment, before the metal powder 15 is fed to the irradiation area Ar1, the absorptance enhancement assisting unit 240 forms the black coating BM by mixing and stirring the black material (carbon black CB) in the aggregate of metal particles that is the raw material of the metal powder 15 so as to attach the black material to the surface of the metal powder. Thus, effects similar to those of the fifth embodiment can be achieved.

According to the first to fifth embodiments, the shaped article manufacturing method of additively shaping an article by sintering or melting and then solidifying the thin film layer 15a of the metal powder 15 through irradiation of the near-infrared laser beam L1 (shaping optical beam) includes: the metal powder feeding step S10 of feeding the thin film layer 15a of the metal powder 15 to the irradiation area Ar1 of the near-infrared laser beam L1 (shaping optical beam); the absorptance enhancement assisting step S20 (S120, S220) of performing the predetermined absorptance enhancement assisting treatment on the thin film layer 15a of the metal powder 15 to enhance the absorptance of the near-infrared laser beam L1 (shaping optical beam) in the metal powder 15 to be irradiated therewith; and the shaping step S30 (S130) of, following implementation of the absorptance enhancement assisting treatment, performing the shaping treatment of additively shaping the article by applying the near-infrared laser beam L1 (shaping optical beam) to the thin film layer 15a of the metal powder 15 fed to the irradiation area Ar1 and thus heating the metal powder 15 (thin film layer 15a) to sinter or melt and then solidify. Thus, a low-cost three-dimensionally shaped article similar to the three-dimensionally shaped article manufactured by the manufacturing apparatuses 100 to 500 can be manufactured.

According to the fifth embodiment, in the absorptance enhancement assisting step S220, the black coating BM is formed on the surface of the metal powder 15 fed to the irradiation area Ar1 by the absorptance enhancement assisting treatment that is performed before the metal powder 15 is fed to the irradiation area Ar1 or after the metal powder 15 is fed to the irradiation area Ar1. Thus, simply forming the black coating BM allows the near-infrared laser beam L1 (shaping optical beam) to be absorbed at a high rate, so that cost can be reduced.

In the first to fourth embodiments, the absorptance enhancement assisting treatment performed by the absorptance enhancement assisting units 40, 140 enhances the absorptance of the near-infrared laser beam L1 (shaping optical beam) by forming the oxide film OM of the predetermined film thickness on the surface of the thin film layer 15a of the metal powder 15. However, the method is not limited to this aspect. Alternatively, the absorptance enhancement assisting treatment may enhance the absorptance of the near-infrared laser beam L1 (shaping optical beam) by imparting irregularity to surfaces of the copper particles of the metal powder 15. In this case, the operations implemented in the absorptance enhancement assisting steps S20, S120 differ from those of the first to fourth embodiments, but the other steps (metal powder feeding step S10, shaping steps S30, S130) can be implemented in the same manner.

As it is based on public knowledge that imparting irregularity to surfaces of copper particles can enhance the absorptance for the near-infrared laser beam L1 (shaping optical beam), detailed description thereof will be omitted. Irregularity can be imparted to surfaces of copper particles by using conditions different from conditions for forming copper particles into a spherical shape when producing copper particles by the publicly-known atomizing method. In this case, too, certain effects can be achieved.

In the first to fourth embodiments, the oxide film OM is formed by applying the short-wavelength laser beam L2 (assisting optical beam) or both the short-wavelength laser beam L2 and the near-infrared laser beam L1 (shaping optical beam) to the surface of the thin film layer 15a of the metal powder 15 in the absorptance enhancement assisting steps S20, S120. However, the method is not limited to this aspect, and the oxide film OM may instead be formed in advance inside a heating furnace. Thus, although the formation efficiency of the oxide film OM is lower, effects similar to those of the above embodiments can be achieved in respect of the shaping steps S30, S130 alone.

In the first to fifth embodiments, the metal powder 15 is copper particles. However, the metal powder is not limited to copper particles, and may instead be another low-absorptance material such as aluminum particles. However, in the first to fourth embodiments, if a low-absorptance material such as aluminum is used as the metal powder, the characteristics of the relation between the laser beam absorptance and the oxide film thickness vary according to the metal. In this case, a predetermined film thickness can be newly set with the characteristics of the relation between the absorptance and the oxide film thickness corresponding to the metal taken into account. As described above, the low-absorptance material refers to a metal material of which the absorptance for the near-infrared laser beam L1 is 30% or less.

In the first to fourth embodiments, when the oxide film OM is formed on the surface of the thin film layer 15a of the metal powder 15 in the absorptance enhancement assisting steps S20, S120, the film thickness estimation section 50 calculates the film thickness of the oxide film OM to be formed. Then, until the oxide film OM of the predetermined film thickness is formed, the power level of the short-wavelength laser beam L2 (assisting optical beam) or both the short-wavelength laser beam L2 and the near-infrared laser beam L1 (shaping optical beam) being applied is kept constant. However, the method is not limited to this aspect. If the film thickness of the oxide film OM calculated by the film thickness estimation section 50 is smaller than a desired film thickness, the power level of the laser beam being applied may be subsequently raised. That is, in another aspect of the method, feedback control may be performed according to the calculated film thickness of the oxide film OM. Thus, the shaped article can be manufactured in a shorter time.

In the first to fourth embodiments, the set value of the film thickness of the oxide film OM formed by the absorptance enhancement assisting treatment of the absorptance enhancement assisting units 40, 140 is set to be within such a range that, in relation to the absorptance having the periodicity, the film thickness is larger than zero but not larger than the first maximum film thickness A corresponding to the first maximum value a that is the maximum value of the absorptance appearing first. However, the method is not limited to this aspect. Alternatively, the film thickness of the oxide film OM may be set to a film thickness exceeding the first maximum film thickness A.

Specifically, the film thickness of the oxide film may be set so that the absorptance is within the range of b % to a % for the film thickness between the first maximum film thickness A corresponding to the first maximum value a and a first minimum film thickness AA corresponding to a first minimum value aa. Alternatively, the film thickness of the oxide film may be set so that the absorptance is within the range of b % to a % at a larger film thicknesses of the oxide film.

In the first to fourth embodiments, the shapes of the irradiation spots of the short-wavelength laser beam L2 and the near-infrared laser beam L1 (shaping optical beam) have been described as circular. However, the shapes are not limited to this aspect. If possible, the shapes of the irradiation spots of the laser beams L1, L2 may be rectangular. In this case, too, effects similar to those of the above embodiments can be achieved.

In the fifth embodiment, the near-infrared laser beam L1 is used as the shaping optical beam, but the short-wavelength laser beam L2 may instead be used as the shaping optical beam. Thus, the manufacturing time of the three-dimensionally shaped article can be further reduced, so that certain effects relative to cost reduction can be expected despite the expensive short-wavelength laser beam L2.

What is claimed is:

1. A shaped article manufacturing apparatus that additively shapes an article by sintering or melting and then solidifying a metal powder through irradiation of a shaping optical beam, the shaped article manufacturing apparatus comprising:
a chamber that is configured to isolate inside air from outside air;
a metal powder feeding device that is provided inside the chamber and feeds the metal powder to an irradiation area of the shaping optical beam;
a shaping optical beam irradiation device that applies the shaping optical beam to the metal powder inside the chamber fed to the irradiation area;
an absorptance enhancement assisting unit that performs a predetermined absorptance enhancement assisting treatment on the metal powder to enhance an absorptance of the shaping optical beam in the metal powder to be irradiated with the shaping optical beam; and
a shaping unit that, following implementation of the absorptance enhancement assisting treatment, performs a shaping treatment of additively shaping the article by applying the shaping optical beam to the metal powder fed to the irradiation area and thus heating the metal powder to sinter or melt and then solidify.

2. The shaped article manufacturing apparatus according to claim 1, further comprising an assisting optical beam irradiation device that applies an assisting optical beam having a wavelength different from a wavelength of the shaping optical beam to the metal powder, wherein
the absorptance enhancement assisting unit implements the absorptance enhancement assisting treatment using at least the assisting optical beam, and
the shaping unit implements the shaping treatment using at least the shaping optical beam.

3. The shaped article manufacturing apparatus according to claim 2, wherein the shaping unit implements the shaping treatment using the shaping optical beam and the assisting optical beam.

4. The shaped article manufacturing apparatus according to claim 2, wherein the absorptance enhancement assisting unit implements the absorptance enhancement assisting treatment using the shaping optical beam and the assisting optical beam.

5. The shaped article manufacturing apparatus according to claim 2, wherein
the absorptance enhancement assisting unit implements the absorptance enhancement assisting treatment using the assisting optical beam, without using the shaping optical beam, and
the shaping unit implements the shaping treatment using the shaping optical beam, without using the assisting optical beam.

6. The shaped article manufacturing apparatus according to claim 2, wherein
the absorptance enhancement assisting treatment is a treatment of forming an oxide film on a surface of the metal powder,
the absorptance enhancement assisting unit forms the oxide film by applying the assisting optical beam with a first spot diameter at a first irradiation position inside the irradiation area of the metal powder, and at the same time applying the shaping optical beam with the first spot diameter at the first irradiation position so as to overlap the assisting optical beam, and
the shaping unit implements the shaping treatment by applying at least the shaping optical beam with the first spot diameter at the first irradiation position that is a formation position of the oxide film.

7. The shaped article manufacturing apparatus according to claim 5, wherein
the absorptance enhancement assisting treatment is a treatment of forming an oxide film on a surface of the metal powder,
the absorptance enhancement assisting unit forms the oxide film by applying the assisting optical beam with a second spot diameter at a second irradiation position inside the irradiation area of the metal powder, and
the shaping unit implements the shaping treatment by applying the shaping optical beam with the second spot diameter at the second irradiation position that is a formation position of the oxide film.

8. The shaped article manufacturing apparatus according to claim 2, wherein
the absorptance enhancement assisting treatment is a treatment of forming an oxide film on a surface of the metal powder,
the absorptance enhancement assisting unit forms the oxide film by applying the assisting optical beam with a third spot diameter at a third irradiation position inside the irradiation area of the metal powder, and at the same time applying the shaping optical beam with a fourth spot diameter, smaller than the third spot diameter, so as to overlap the assisting optical beam, and
the shaping unit implements the shaping treatment by applying at least the shaping optical beam with the fourth spot diameter at a formation position of the oxide film.

9. The shaped article manufacturing apparatus according to claim 2, wherein
the absorptance enhancement assisting treatment is a treatment of preheating the metal powder and forming an oxide film on a surface of the preheated metal powder,
the absorptance enhancement assisting unit implements a preheating treatment by applying at least the assisting optical beam with a fifth spot diameter at a fifth irradiation position inside the irradiation area of the metal powder before applying the shaping optical beam,
the absorptance enhancement assisting unit forms the oxide film by applying the assisting optical beam with the fifth spot diameter at the fifth irradiation position inside the irradiation area of the metal powder, and at the same time applying the shaping optical beam with a sixth spot diameter, smaller than the fifth spot diameter, so as to overlap the assisting optical beam, and
the shaping unit implements the shaping treatment by applying at least the shaping optical beam with the sixth spot diameter at a formation position of the oxide film.

10. The shaped article manufacturing apparatus according to claim 9, wherein the absorptance enhancement assisting unit implements the preheating treatment using the assisting optical beam, without using the shaping optical beam.

11. The shaped article manufacturing apparatus according to claim 6, wherein
the absorptance enhancement assisting unit includes:
a film thickness estimation section that estimates a film thickness of the oxide film formed on the surface of the metal powder by the absorptance enhancement assisting treatment; and
a treatment switching determination section that determines whether the estimated film thickness of the oxide film has reached a predetermined film thickness, and, upon determining that the predetermined film thickness has been reached, switches the absorptance enhancement assisting treatment to the shaping treatment by the shaping unit, and
the film thickness estimation section includes:
a surface temperature measurement part that measures a temperature of the surface of the metal powder on which the oxide film is formed;
an irradiation time measurement part that measures an irradiation time for which the assisting optical beam or both the assisting optical beam and the shaping optical beam are applied to the surface of the metal powder to form the oxide film; and
an oxide film thickness calculation part that calculates an estimated film thickness of the oxide film based on the measured surface temperature and the measured irradiation time.

12. The shaped article manufacturing apparatus according to claim 11, wherein
in relation to the film thickness of the oxide film, the absorptance of the shaping optical beam in the metal powder has a periodicity of a maximum value and a minimum value appearing alternately as the film thickness changes in a plus direction, and has such a characteristic that the absorptance becomes lowest when the film thickness of the oxide film is zero, and
the absorptance enhancement assisting unit sets the predetermined film thickness of the oxide film having a thickness exceeding zero to be within such a range that, in relation to the absorptance having the periodicity, the film thickness is larger than zero but not larger than a first maximum film thickness corresponding to a first maximum value that is the maximum value of the absorptance appearing first.

13. The shaped article manufacturing apparatus according to claim 2, wherein
the shaping optical beam is a laser beam with a near-infrared wavelength, and
the assisting optical beam is a short-wavelength laser beam with a wavelength shorter than the near-infrared wavelength.

14. The shaped article manufacturing apparatus according to claim 1, wherein
the absorptance enhancement assisting treatment is a treatment of forming a black coating by attaching a black material to a surface of the metal powder that is fed to the irradiation area by the metal powder feeding device, and
the absorptance enhancement assisting unit forms the black coating on the surface of the metal powder fed to the irradiation area by the absorptance enhancement assisting treatment that is performed before the metal powder is fed to the irradiation area or after the metal powder is fed to the irradiation area.

15. The shaped article manufacturing apparatus according to claim 14, wherein, when, following implementation of the absorptance enhancement assisting treatment, the shaping unit applies the shaping optical beam to the surface of the metal powder and thus heats the metal powder to sinter or melt and then solidify, the black coating does not remain inside the shaped article that has been solidified and additively shaped.

16. The shaped article manufacturing apparatus according to claim 14, wherein the absorptance enhancement assisting unit includes a black coating forming device that is provided inside the chamber and forms the black coating on the surface of the metal powder after the metal powder is fed to the irradiation area.

17. The shaped article manufacturing apparatus according to claim 16, wherein an area of the surface of the metal powder in which the absorptance enhancement assisting unit forms the black coating is an area corresponding to a predetermined irradiation position in the surface of the metal powder at which the shaping unit applies the shaping optical beam to perform the shaping treatment following implementation of the absorptance enhancement assisting treatment.

18. The shaped article manufacturing apparatus according to claim 14, wherein, each time the metal powder is fed to the irradiation area by the metal powder feeding device, the black coating is formed on the surface of the metal powder by the absorptance enhancement assisting unit.

19. The shaped article manufacturing apparatus according to claim 14, wherein, before the metal powder is fed to the irradiation area, the absorptance enhancement assisting unit forms the black coating by mixing and stirring the black material in an aggregate of metal particles that is a raw material of the metal powder so as to attach the black material to the surface of the metal powder.

20. The shaped article manufacturing apparatus according to claim 14, wherein the black material forming the black coating is carbon black.

21. The shaped article manufacturing apparatus according to claim 14, wherein the shaping optical beam is a laser beam with a near-infrared wavelength.

22. The shaped article manufacturing apparatus according to claim 1, wherein the metal powder is a copper powder.

23. A shaped article manufacturing method of additively shaping an article by sintering or melting and then solidifying a metal powder through irradiation of a shaping optical beam, the shaped article manufacturing method comprising:
feeding the metal powder to an irradiation area of the shaping optical beam;
performing a predetermined absorptance enhancement assisting treatment on the metal powder to enhance an absorptance of the shaping optical beam in the metal powder to be irradiated with the shaping optical beam; and
following implementation of the absorptance enhancement assisting treatment, performing a shaping treatment of additively shaping the article by applying the shaping optical beam to the metal powder fed to the irradiation area and thus heating the metal powder to sinter or melt and then solidify.

24. The shaped article manufacturing method according to claim 23, wherein, in the absorptance enhancement assisting treatment, a black coating is formed on a surface of the metal powder fed to the irradiation area by the absorptance enhancement assisting treatment that is implemented before the metal powder is fed to the irradiation area or after the metal powder is fed to the irradiation area.
